(19) United States
(12) Patent Application Publication
(10) Pub. No.: US 2013/0308078 A1
(43) Pub. Date: Nov. 21, 2013

(54) 3D DISPLAY DEVICE AND 3D DISPLAY SYSTEM

(71) Applicant: FUJIFILM Corporation, Tokyo (JP)

(72) Inventors: Hiroshi SATO, Kanagawa (JP); Takashi YONEMOTO, Kanagawa (JP); Megumi SEKIGUCHI, Kanagawa (JP)

(73) Assignee: FUJIFILM Corporation, Tokyo (JP)

(21) Appl. No.: 13/948,707

(22) Filed: Jul. 23, 2013

Related U.S. Application Data
(63) Continuation of application No. PCT/JP2012/051420, filed on Jan. 24, 2012.

(30) Foreign Application Priority Data
Jan. 24, 2011 (JP) 2011-012276

(51) Int. Cl. G02B 27/26

(52) U.S. Cl. CPC G02B 27/26
USPC 349/96

(57) ABSTRACT

Provide is a 3D display device and a 3D display system having reduced crosstalk and reduced color shift generating in a diagonal direction during white display. A 3D display device comprising: a liquid crystal cell for image display; a first polarizing film and a polarization-converting liquid crystal cell in this order in front of the liquid crystal cell for image display; at least one retardation layer between the polarization-converting liquid crystal cell and the first polarizing film and/or in front of the polarization-converting liquid crystal cell, the at least one retardation layer comprising a polymer film or consisting of a polymer film, wherein the polymer films have a retardation Re (550) in plane at a wavelength of 550 nm of −30 to 100 nm and a retardation Rth (550) in the thickness direction at a wavelength of 550 nm of 50 to 180 nm.

The present application is a continuation of PCT/JP2012/051420 filed on Jan. 24, 2012 and claims priority under 35 U.S.C. §119 of Japanese Patent Application No. 012276/2011, filed on Jan. 24, 2011.

### TECHNICAL FIELD

The present invention relates to an active retarder 3D display device and 3D display system.

### BACKGROUND ART

Various three-dimensional (3D) display techniques have been proposed until now to display 3D images, including two typical techniques: the first one that needs glasses and the other one that needs no glasses.

The technique that needs no glasses has some disadvantages; the viewable position is limited, crosstalk indicating partial overlap of right and left images occurs at a position deviating from the optimum point, leading to considerable degradation of the image quality. In contrast, the technique that needs glasses can provide high-quality 3D images without limitation of the viewable position.

In one 3D display scheme, two TN liquid crystal display plates are laminated, right and left eye images are displayed superimposed on the rear TN liquid crystal display plate while polarization of the image for every pixel is controlled on the front TN liquid crystal display plate, and the right and left images are segmented to be visualized through polarizing glasses.

In PTL 1, a stereoscopic display having such a structure unifies both the front and rear TN liquid crystal plates to be an O mode to reduce coloring when the right or left eye image are in an E mode. However, the stereoscopic display in PTL 1 assumes that both the front and rear liquid crystal plates are of a TN type, and have to be unified to be an O mode. This limits display designs. A 3D display device would be advantageous in practical use that has outstanding 3D display characteristics and wide view angle characteristics, without control of the modes of a liquid crystal cell for image display and a polarization-converting liquid crystal cell and undue limitations on the configuration of each member.

### CITATION LIST

### Patent Literature

PTL 1: Japanese Patent Application Laid-Open Publication No. 2010-134393

PTL 2: Japanese Patent Application Laid-Open Publication No. 2010-134394

### SUMMARY OF THE INVENTION

### Technical Problem

An object of the present invention, which has been made in view of the above problems, is to provide a 3D display device and a 3D display system having outstanding 3D display characteristics and wide view angle characteristics, particularly having reduced crosstalk and reduced color shift generating in a diagonal direction during white display.

### Solution to Problem

The solutions to the problems described above are as follows:

<1> A 3D display device comprising:
a liquid crystal cell for image display;
a first polarizing film and a polarization-converting liquid crystal cell in this order in front of the liquid crystal cell for image display;

at least one retardation layer between the polarization-converting liquid crystal cell and the first polarizing film and/or in front of the polarization-converting liquid crystal cell, the at least one retardation layer comprising a polymer film or consisting of a polymer film,

wherein the polymer films have a retardation Re (550) in plane at a wavelength of 550 nm of −30 to 100 nm and a retardation Rth (550) in the thickness direction at a wavelength of 550 nm of 50 to 180 nm.

<2> The 3D display device in accordance with <1>, wherein the slow axis of the polymer film is orthogonal to, is parallel to, or intersects, at 45°, the transmission axis of the first polarizing film.
<3> The 3D display device in accordance with <1> or <2>, which comprises at least two retardation layers, one of the retardation layers being disposed between the polarization-converting liquid crystal cell and the first polarizing film, and other one of the retardation layers being disposed in front of the polarization-converting liquid crystal cell.
<4> The 3D display device in accordance with <3>, wherein the polymer films are disposed such that slow axes thereof are orthogonal to each other.
<5> The 3D display device in accordance with any one of <1> to <4>, further comprising an additional polarizing film between the liquid crystal cell for image display and the first polarizing film, the additional polarizing film having a transmission axis parallel to the transmission axis of the first polarizing film.
<6> The 3D display device in accordance with any one of <1> to <5>, further comprising a second polarizing film behind the liquid crystal cell for image display, the second polarizing film having a transmission axis orthogonal to the transmission axis of the first polarizing film.
<7> The 3D display device in accordance with any one of <1> to <6>, wherein the retardation layer comprises a polymer film and an optically anisotropic layer on the polymer film, the optically anisotropic layer comprising a composition containing a liquid crystal compound.
<8> The 3D display device in accordance with any one of <1> to <7>, wherein the polymer film is a cellulose acylate film.
<9> The 3D display device in accordance with any one of <1> to <8>, wherein the polymer film is an optically biaxial polymer film.
<10> The 3D display device in accordance with any one of <1> to <9>, wherein the first polarizing film and the polarization-conversion liquid crystal cell are in an E mode or an O mode.
<11> The 3D display device in accordance with any one of <1> to <10>, wherein the liquid crystal cell for image display is a VA mode, the transmission axis of the first polarizing film is parallel to the horizontal or vertical direction of a display face.
<12> The 3D display device in accordance with any one of <1> to <11>, wherein the polarization-conversion liquid crystal cell is a TN mode.
<13> The 3D display device in accordance with any one of <1> to <11>, wherein the polarization-conversion liquid crystal cell is a VA mode.
<14> A 3D display system comprising:
a 3D display device in accordance with any one of <1> to <13>; and
a third polarizing film that transmits images displayed on the 3D display system to be visualized as 3D images.

### Advantageous Effects of Invention

The present invention can provide a 3D display device and a 3D display system having outstanding 3D display characteristics and wide view angle characteristics, particularly having reduced crosstalk and reduced color shift generating in a diagonal direction during white display.

### BRIEF DESCRIPTION OF DRAWINGS

FIG. 1 is a schematic cross-sectional view showing an example 3D display device.

FIG. 2 is a schematic cross-sectional view showing an example 3D display device.

FIG. 3 is a drawing showing example embodiments of an E mode, an O mode, and a 45° mode of the present invention.

### DESCRIPTION OF EMBODIMENTS

The invention is described in detail hereinunder. In this description, the numerical range expressed by the wording “a number to another number” means the range that falls between the former number indicating the lowermost limit of the range and the latter number indicating the uppermost limit thereof. First described are the terms used in this description.

In this description, Re(λ) and Rth(λ) are retardation (nm) in plane and retardation (nm) along the thickness direction, respectively, at a wavelength of λ. Re(λ) is measured by applying light having a wavelength of λ nm to a film in the normal direction of the film, using KOBRA 21ADH or WR (by Oji Scientific Instruments). The selection of the measurement wavelength may be conducted according to the manual-exchange of the wavelength-selective-filter or according to the exchange of the measurement value by the program. When a film to be analyzed is expressed by a monoaxial or biaxial index ellipsoid, Rth(λ) of the film is calculated as follows. This measuring method may be used for measuring the mean tilt angles at the alignment layer interface and at the opposite interface of discotic liquid crystal molecules in an optically anisotropic layer.

Rth(λ) is calculated by KOBRA 21ADH or WR on the basis of the six Re(λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film. In the above, when the film to be analyzed has a direction in which the retardation value is zero at a certain inclination angle, around the in-plane slow axis from the normal direction as the rotation axis, then the retardation value at the inclination angle larger than the inclination angle to give a zero retardation is changed to negative data, and then the Rth(λ) of the film is calculated by KOBRA 21ADH or WR. Around the slow axis as the inclination angle (rotation angle) of the film (when the film does not have a slow axis, then its rotation axis may be in any in-plane direction of the film), the retardation values are measured in any desired inclined two directions, and based on the data, and the estimated value of the mean refractive index and the inputted film thickness value, Rth may be calculated according to formulae (A) and (B):

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( {n}_{2} cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad ( A )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (B)

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value, Rth(λ) of the film may be calculated by KOBRA 21ADH or WR. In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below: cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated.

Terms “parallel” and “orthogonal” used herein refer to being within the range of an exact angle ±less than 10°, preferably less than ±5°, and more preferably less than ±2°. The term “slow axis” refers to the direction in which the refractive index reaches a maximum.

Unless stated otherwise, the wavelength λ for measuring the refractive index is =550 nm in the range of visible light, and the wavelength for measuring the Re and Rth is also 550 nm.

With a retardation layer which is disposed between the polarization-converting liquid crystal cell and the first polarizing film, if the slow axis of a polymer film in the retardation layer lies in a direction orthogonal to the absorption axis of the first polarizing film, Re>0 is defined, and if the slow axis lied in a direction parallel to the absorption axis of the first polarizing film, Re<0 is defined.

With a retardation layer which is disposed in front of the polarization-converting liquid crystal cell, if the slow axis of a polymer film in the retardation layer lies in a direction parallel to the absorption axis of the first polarizing film, Re>0 is defined, and if the slow axis lies in a direction orthogonal to the absorption axis of the first polarizing film, Re<0 is defined.

The term “polarizing film” is herein used in distinction from the term “polarizing plate”, and the latter refers to a laminate having a transparent protective film that protects the former on at least one face of the former.

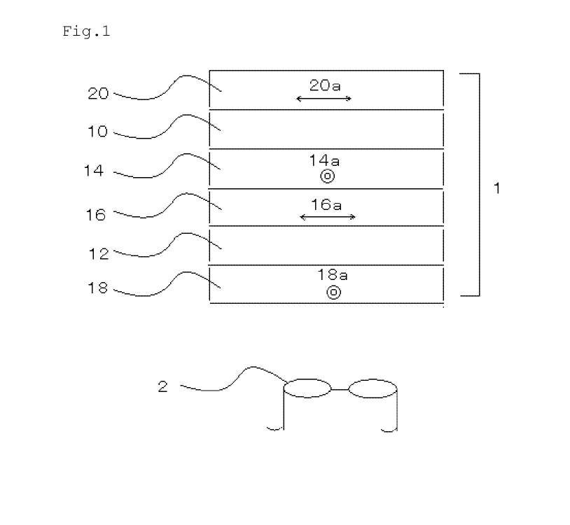

FIG. 1 shows a schematic cross-sectional view of an example 3D display device of the present invention. The relative relationship on the thickness of each layer in the drawing is not necessarily consistent with the actual relative relationship on the thickness of each layer in a liquid crystal display.

A 3D display device 1 shown in FIG. 1 includes a liquid crystal cell for image display 10 and a polarization-converting liquid crystal cell 12. A backlight is disposed further behind the liquid crystal cell for image display 10, and the polarization-converting liquid crystal cell 12 is disposed at the side of the display face. A viewer who wears polarizing glasses 2 perceives images through the polarization-converting liquid crystal cell 12. For example, in one embodiment wherein right and left eye images from the polarization-converting liquid crystal cell 12 are linearly polarized images which have mutually orthogonal polarization axes, the viewer wears mutually orthogonal linear polarizing glasses. In another embodiment wherein right and left eye images from the polarization-converting liquid crystal cell 12 are circularly polarized images in mutually opposite directions, the viewer wears circular polarizing glasses in mutually opposite directions.

A first polarizing film 14 is disposed between the liquid crystal cell for image display 10 and the polarization-converting liquid crystal cell 12. The transmission axis 14a of the first polarizing film 14 is in an orthogonal relation to the transmission axis 20a of a second polarizing film 20 disposed on the backlight side, that is, these axes are disposed in a cross nicol state.

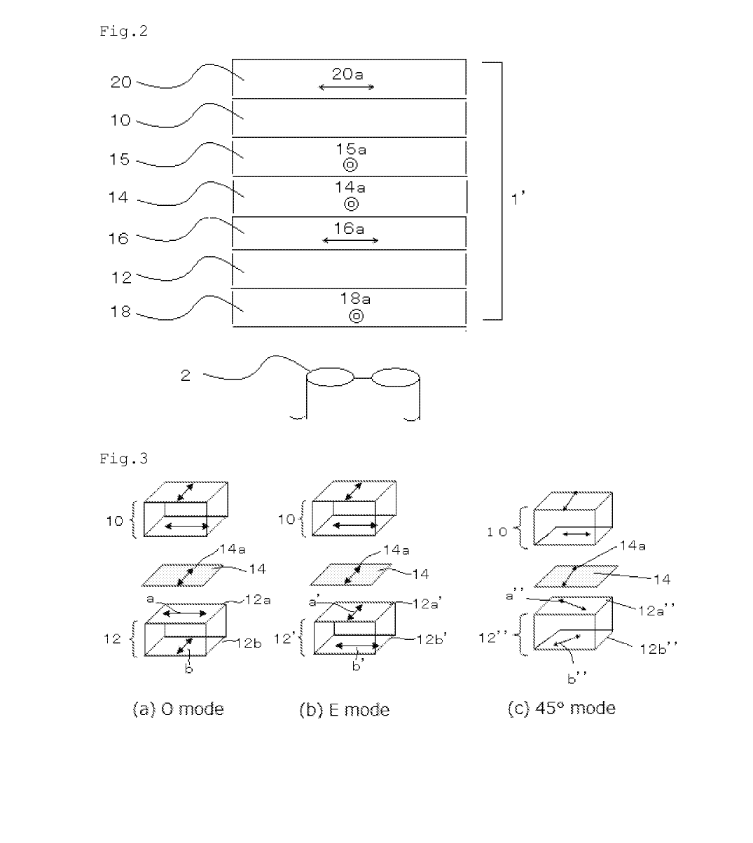

In FIG. 1, the first polarizing film 14 is also utilized for an image displaying function of the liquid crystal cell for image display 10, and for a polarization converting function of the polarization-converting liquid crystal cell 12. Apart from the first polarizing film 14, another polarizing film 15 utilized for the image displaying function, for example, may be disposed as shown in FIG. 2, resulting in functional separation, provided that the transmission axis 15a of the polarizing film 15 must be parallel to the transmission axis 14a of the first polarizing film 14. The structure shown in FIG. 1 is preferable from the points of view of the thinner profile and the front luminance, while the structure shown in FIG. 2 can separate the image displaying function from the polarization converting function, and may be more advantageous in the manufacturing process. The first polarizing film 14 and the polarizing film 15 have their respective protective films for protecting themselves disposed therebetween. Such a protective film may preferably be an optically isotropic polymer film having a low Re and a low Rth.

A retardation layer 16 comprising or consisting of a polymer film is disposed between the polarization-converting liquid crystal cell 12 and the first polarizing film 14 so that the slow axis 16a of the polymer film is disposed orthogonal to the transmission axis 14a, while on the front surface of the polarization-converting liquid crystal cell 12, a retardation layer 18 comprising or consisting of a polymer film is disposed so that the slow axis 18a of the polymer film is disposed parallel to the transmission axis 14a. The respective polymer films in the retardation layers 16 and 18 have a Re (550) of −30 to 100 nm (preferably −10 to 80 nm), and have a Rth (550) of 50 to 180 nm (preferably 60 to 150 nm). The retardation layers 16 and 18 that meet these properties are disposed so that the slow axis 16a of a polymer film the retardation layer 16 has and the slow axis 18a of a polymer film the retardation layer 18 has are disposed orthogonal to and parallel to the transmission axis 14a of the first polarizing film 14 respectively. This reduces crosstalk, improves 3D display characteristics, reduces color shift generating in a diagonal direction during white display, and also improves view angle characteristics.

The retardation layers 16 and 18 each may be of a mono-layer structure, or of a multi-layer structure. One example is a single polymer film, or a laminate of two or more polymer films; another example is a laminate of one or more polymer films with an optically-anisotropic layer composed of a composition comprising a liquid crystal compound thereon. In an embodiment where the polarization-converting liquid crystal cell 12 is a TN mode liquid crystal cell, a laminate of a polymer film with an optically-anisotropic layer comprising a discotic liquid crystal fixed in a discotic alignment state is preferably used as the retardation layers 16 and 18 due to its enhanced effect of reducing crosstalk. Particularly, an optically-anisotropic layer that comprises a discotic liquid crystal fixed in a hybrid alignment (hereinafter, also referred to as “inverse hybrid alignment”) state where the tilt angle at the interface with a polymer film which is a support (the tilt angle between the disc plane of the discotic liquid crystal and the layer) is large while the tilt angle at the opposite interface (the interface with air in lamination) is narrow is preferably used also due to its effect of improving the front contrast. The details on the retardation layers that can be used for the present invention will be given below.

FIGS. 1 and 2 show a structure of the retardation layers 16 and 18 which are disposed such that the slow axis 16a of a polymer film of the retardation layer 16 and the slow axis 18a of a polymer film of the retardation layer 18 are disposed orthogonal to and parallel to, respectively, the transmission axis 14a of the first polarizing film 14. Alternatively, similar effects can also be achieved by a structure of the retardation layers 16 and 18 which are disposed such that the slow axis 16a of a polymer film of the retardation layer 16 and the slow axis 18a of a polymer film of the retardation layer 18 are disposed parallel to and orthogonal to, respectively, the transmission axis 14a of the first polarizing film 14. Depending on the drive mode of the polarization-converting liquid crystal cell 12 or optical properties thereof, similar effects may be obtained even when one of the retardation layers 16 and 18 is not disposed. In an embodiment where only one retardation layer is used, the retardation layer used is preferably disposed between the polarization-converting liquid crystal cell 12 and the first polarizing film 14.

The liquid crystal cell for image display 10 and the polarization-converting liquid crystal cell 12 are in any drive mode, and may be in the same drive mode or in different drive modes. Different modes such as twisted nematic (TN), supertwisted nematic (STN), vertical alignment (VA), in-plane switching (IPS), optically compensated bend cell (OCB) modes can be available.

The liquid crystal cell 10, which is used for displaying right and left eye images, is a drive mode that is selected from the point of view of display characteristics. For example, the VA mode and the IPS mode are superior in view angle characteristics, and are thus suitable as a drive mode for a liquid crystal cell for image display 1. The liquid crystal cell 10 can have any structure, particularly a conventional liquid crystal cell structure. The liquid crystal cell 10 may comprise, for example, a pair of substrates which are disposed facing each other (not shown), and a liquid crystal layer sandwiched between the pair of substrates, and if required, a color filter layer. Moreover, an optical view angle compensation film may be disposed between the second polarizing film 20 on the backlight side and the liquid crystal cell 10 in FIGS. 1 and 2, between the first polarizing film 14 and the liquid crystal cell 10 in FIG. 1, or between the polarizing film 15 and the liquid crystal cell 10 in FIG. 2.

The liquid crystal cell 12 is used for controlling polarization of the right and left eye images for every pixel to convert the right and left eye images displayed by the liquid crystal cell 10 into right and left eye polarized images. One example is a liquid crystal cell that has a retardation of 0 during voltage application, and a retardation of λ/2 during no voltage application. In this embodiment, if the on-off control of the applied voltage to the liquid crystal cell 12 is synchronized with the right and left eye images displayed by the liquid crystal cell 10, the right and left eye images can emerge as the linearly polarized images which have mutually orthogonal polarization axes from the liquid crystal cell 12. These linearly polarized images are segmented through polarizing glasses which have mutually orthogonal transmission axes into the left eye image incident upon a left eye lens and into the right eye image incident upon a right eye lens, and are perceived through stereopsis.

The drive mode of the polarization-converting liquid crystal cell 12, which is required to have a high response speed will be selected from the point of view of response speed. The TN mode, which has a high response speed, is suitable in use for the liquid crystal cell 12. In an embodiment of a TN mode liquid crystal cell 12, during no voltage application, liquid crystal molecules in the liquid crystal cell 12 are aligned in the direction of rubbing treatment that is given to the inner surface of the substrate. However, whether the alignment state is an O mode, an E mode, or a 45° mode, similar effects may be obtained in view of the relationship to the transmission axis 14a of the first polarizing film 14. In this respect, the present invention different from the conventional art described in PTL 1 that inevitably includes two TN liquid crystal display plates stacked in an O mode to achieve its effects. That is, in the present invention, the liquid crystal cell 12 may be correlated with the first polarizing film 14 such that the transmission axis 14a of the first polarizing film 14 is orthogonal to the alignment direction of liquid crystal molecules in the liquid crystal cell 12 during no voltage application, that is, the direction a of the rubbing treatment that is given to the inner surface of the substrate 12a in the liquid crystal cell 12, as shown in FIG. 3(a), or such that the transmission axis 14a of the first polarizing film 14 is parallel to the alignment direction of liquid crystal molecules in the liquid crystal cell 12 during no voltage application, that is, the direction a′ of the rubbing treatment that is given to the inner surface of the substrate 12a′ in the liquid crystal cell 12, as shown in FIG. 3(b). Moreover, as shown in FIG. 3(c), the transmission axis 14a of the first polarizing film 14 may intersect the alignment direction of liquid crystal molecules in the liquid crystal cell 12 during no voltage application, that is, the direction a″ of the rubbing treatment that is given to the inner surface of the substrate 12a″ in the liquid crystal cell 12 at an angle of 45°. In addition, in the TN mode, the rubbing treatment is given to the inner surfaces of the substrates 12b, 12b′, and 12b″ opposing to the substrates 12a, 12a′, and 12a″ in the liquid crystal cell 12 in the directions b, b′, and b″ orthogonal to the directions a, a′, and a″ respectively, and twisted orientation appears during no voltage application.

The polarization-converting liquid crystal cell 12 may also have any structure. Specifically, any structure can be used that has a variable alignment state of the liquid crystal by voltage application synchronized with switching of the display of right and left eye images by the liquid crystal display part 10, to convert polarization of the incident light. One example structure can be of a liquid crystal layer disposed between substrates having a pair of electrodes.

The transmission axis 14a of the first polarizing film 14 and the transmission axis 20a of the second polarizing film 20 are disposed orthogonal to each other in a normally black mode. Within such an orthogonal arrangement, they may be disposed in any direction. In an embodiment of a VA mode or IPS mode liquid crystal cell 10, one of these axes is preferably disposed parallel to the horizontal direction of the display face, whereas the other is disposed parallel to the vertical direction of the display face.

The present invention also relates to a 3D display system that includes at least a 3D display device of the present invention, and polarizing glasses through which a viewer perceives polarized images from the 3D display device, as shown in FIGS. 1 and 2. In one embodiment wherein right and left eye polarized images displayed by the 3D display device displays are linearly polarized images which have mutually orthogonal polarization axes, the viewer wears mutually orthogonal linear polarizing glasses. In another embodiment wherein right and left eye images from the polarization-converting liquid crystal cell 12 are circularly polarized images in mutually opposite directions, the viewer wears circular polarizing glasses in mutually opposite directions. Also, these polarizing glasses may have a shutter function that synchronizes with images displayed by the 3D display device.

Various components used for the 3D display device of the present invention will be described in detail below.

### 1. Retardation Layer

The 3D display device of the present invention includes at least one retardation layer comprising or consisting of a polymer film between the first polarizing film and the polarization-converting liquid crystal cell and/or in front of the polarization-converting liquid crystal cell. As shown in FIGS. 1 and 2, two retardation layers are preferably disposed at the respective positions, and preferably have equal optical properties. The retardation layers are disposed such that the slow axis of the polymer film is orthogonal to or parallel to the transmission axis of the first polarizing film. Preferably, the retardation layer comprising or consisting of a polymer film can also function as a protective film for the first polarizing film.

The polymer film of the retardation layer has a retardation Re (550) in plane of −30 to 100 nm at a wavelength of 550 nm, and a retardation Rth (550) along the thickness direction of 50 to 180 nm at a wavelength of 550 nm. One example retardation layer is of a single polymer film. In an embodiment wherein each retardation layer is composed of a single polymer film, and two retardation layers are disposed behind and in front of the polarization-converting liquid crystal cell as shown in FIGS. 1 and 2, the polymer film of the retardation layer preferably has an Re (550) of −10 to 80 nm, and more preferably an Rth (550) of 60 to 150 nm. The polymer film may be optically uniaxial or biaxial, and preferably biaxial.

Example of the usable polymer films include: cellulose acylate, polycarbonate series polymers, polyester series polymers such as polyethylene terephthalate and polyethylene naphthalate, acryl series polymers such as polymethylmethacrylate, and styrene series polymers such as polystyrene and acryl nitrile/styrene copolymer (AS resin). Specific examples thereof include also polyolefins such as polyethylene and polypropylene, polyolefin series polymers such as ethylene/propylene copolymers, vinyl chloride series polymers, amide series polymers such as nylon and aromatic polyamide, imide series polymers, sulfone series polymers, polyether sulfone series polymers, polyether ether ketone series polymers, polyphenylene sulfide series polymers, vinylidene chloride series polymers, vinyl alcohol series polymers, vinyl butyral series polymers, acrylate series polymers, polyoxymethylene series polymers, epoxy series polymers and any mixtures thereof. Moreover, one or more polymers can be selected from the group consisting of and mixed polymers thereof, and be used as a main component for producing polymer films. The resulting polymer film can be used to produce retardation layers that meet the characteristics described above.

One example polymer film that can be used as a retardation layer is a cellulose acylate film, and preferred is a film comprising a cellulose acetate having acetyl groups as a main component. Particularly preferred is a polymer film comprising or consisting of a layer with a low degree of substitution comprising a cellulose acylate having a low degree of substitution (preferably, a cellulose acetate having a low degree of substitution) that satisfies expression (1) below as a main component, or a polymer film comprising the layer with a low degree of substitution.

2.0<Z1<2.7 (1)

wherein, Z1 represents the degree of total acyl (preferably acetyl) substitution of a cellulose acylate.

Details on the production of a polymer film using a cellulose acylate as a main component that satisfies expression (1) can be found in Japanese Patent Application Laid-Open Publication No. 2010-58331.

Formation of Polymer Films

A cellulose acylate film used as a part or all of the polymer film can be prepared by different processes. Examples of the preparation include solution casting (solvent casting), melt extrusion, calendering, and compression molding processes. Among these film-forming processes, preferred is solution casting (solvent casting) or melt extrusion, and especially preferred is solution casting. In the solution casting, a solution (dope) of a cellulose acylate in an organic solvent can be used to produce a film. Any additive may be added at any point of time during the preparation of the dope. The formation of cellulose acylate films available in the present invention can be found in the description on paragraphs [0219] to [0224] in Japanese Patent Application Laid-Open Publication No. 2006-184640.

Retardation of the cellulose acylate film used for the present invention may be adjusted by stretching treatment. The stretching treatment may be a uniaxial stretching or biaxial stretching treatment. The biaxial stretching treatment is preferably carried out by simultaneous biaxial stretching or successive biaxial stretching. The successive biaxial stretching is suitable for continuous production. In the successive biaxial stretching, the dope is cast onto a band or a drum, and the resulting film is then peeled off. The film is stretched in the transverse direction (or the longitudinal direction) and then in the longitudinal direction (or the transverse direction).

Processes of stretching the film in the transverse direction are described in Japanese Patent Application Laid-Open Publication Nos. 62-115035, 4-152125, 4-284211, 4-298310, and 11-48271. The film is stretched at normal temperature or elevated temperatures. Preferably, the elevated temperature does not exceed the glass transition temperature of the film. The stretching treatment of the film may be carried out during the drying treatment. The stretching treatment of the film containing a residual solvent may show special effects.

In the longitudinal stretching, the film can readily stretched by adjusting the speed of the film conveyor roller to set the film winding speed higher than the film peeling speed.

In the transverse stretching, the film can be stretched by conveying the film while holding its edges with a tenter, and expanding the tenter width.

One example process of formation of the cellulose acylate films that meet the optical properties involves forming film by any of the film forming processes (preferably, a solution film forming process), and subsequently stretching the resulting film by 0 to 60% (more preferably, 0 to 50%) stretching (the ratio of the increment by stretching to the original length).

Another example retardation layer that can be used for the present invention is a laminate of a polymer film (a support) with an optically-anisotropic layer composed of a composition comprising a liquid crystal compound thereon. In an embodiment of a TN mode polarization-converting liquid crystal cell, such laminates are preferably disposed in front of and behind the polarization-converting liquid crystal cell as shown in FIGS. 1 and 2, and are preferably disposed symmetrically about the liquid crystal cell, with each optically-anisotropic layer disposed adjacent to the liquid crystal cell. This embodiment will be described in detail below.

The preferred range of Re and Rth of the polymer film that is used as a support is similar to that described above, and particularly, Re is preferably −10 to 70 nm, and Rth is more preferably 80 to 180 nm.

The optically-anisotropic layer is preferably formed of a polymerizable composition comprising a liquid crystal compound. The liquid crystal compound used for forming the optically-anisotropic layer may be a rod-like liquid crystal compound or a discotic liquid crystal compound. In an embodiment of a TN mode polarization-converting liquid crystal cell, a discotic (disk-shaped) liquid crystal compound is preferably used. Examples of the discotic liquid crystal compounds include triphenylene compounds, and tri-substituted benzene compounds having substituents at 1, 3, and 5 positions on a benzene ring.

Liquid crystal molecules in the optically-anisotropic layer are in any alignment state. In an embodiment of a TN mode polarization-converting liquid crystal cell, the liquid crystal compound molecules in the optically-anisotropic layer are preferably fixed in a hybrid alignment state. In the hybrid alignment state, where the angle between the long axis of the molecule and the layer face in the rod-like liquid crystal compound or the angle between the disc plane of the molecule and the layer face in the discotic liquid crystal compound (hereinafter, referred to as “tilt angle”) vary (increase or decrease) in the layer thickness direction. The optically-anisotropic layer is generally formed by orienting a composition comprising a discotic liquid crystal compound on the surface of an alignment film, and the resulting layer has an interface with the alignment film and an interface with air. The hybrid alignment has two modes: one mode in which the tilt angle increases on the side of the alignment film interface and decreases on the side of the air interface (that is, the mode in which the tilt angle decreases from the alignment film interface toward the air interface, hereinafter, referred to as “negative hybrid alignment”), and the other mode in which the tilt angle decreases on the side of the alignment film interface and increases on the side of the air interface (that is, the tilt angle increases from the alignment film interface toward the air interface, hereinafter, referred to as “positive hybrid alignment”). Either mode may be used from points of view of reduction in crosstalk and color shift during a white display mode, and preferred is reverse hybrid alignment in terms of front contrast.

Examples of discotic compounds that can be used for the present invention include benzene derivatives (described in Research report by C. Destrade et al., Mol. Cryst., Vol. 71, p. 111 (1981)), truxene derivatives (described in Research report by C. Destrade et. al., Mol. Cryst., Vol. 122, p. 141 (1985), and Physics lett., A, Vol. 78, p. 82 (1990)), cyclohexane derivatives (described in Research report by B. Kohne et. al., Angew. Chem., Vol. 96, p. 70 (1984)), and azacrown-based or phenylacetylene-based macrocycles (described in Research report by J. M. Lehn et. al., J. Chem. Commun., p. 1794 (1985), and Research report by J. Zhang et. al., J. Am. Chem. Soc., Vol. 116, p. 2655 (1994)).

The discotic liquid crystal compound preferably has a polymerizable group so as to allow the compound to be fixed.

For example, a possible structure of the discotic liquid crystal compound has a polymerizable group as a substituent connected to the discotic core thereof. However, a discotic liquid crystal compound has a polymerizable group connected directly to the discotic core thereof, making it difficult to keep its alignment state during polymerization reaction. Therefore, preferred is a structure of a discotic liquid crystal compound having a linking group between the discotic core and the polymerizable group. That is, the discotic liquid crystal compound having polymerizable groups is preferably a compound represented by the following formula:

D(-L-P)ₙ

wherein, D represents a discotic core, L represents a bivalent linking group, and P represents a polymerizable group, and n represents an integer of 1 to 12. Preferable specific examples of the discotic core (D), the bivalent linking group (L) and the polymerizable group (P) in the formula are chemical entities (D1) to (D15), (L1) to (L25), and (P1) to (P18), respectively, described in Japanese Patent Application Laid-Open Publication No. 2001-4837, the description of which can preferably be incorporated. The transition temperature of the liquid crystal compound from a discotic nematic liquid crystal phase to a solid phase is preferably 30 to 300° C., and more preferably 30 to 170° C.

An optically-anisotropic layer formed of a tri-substituted benzene-based discotic liquid crystal compound represented by Formulae (I) and (I′) is preferably used to produce better advantageous effects. The optically-anisotropic layer formed of a tri-substituted benzene-based discotic liquid crystal compound represented by Formulae (I) and (I′) preferably produces the negative hybrid alignment state stably by selecting alignment films and additives if desired. Moreover, a coating solution comprising the liquid crystal compound shows a tendency to have a relatively low viscosity, and then preferably has good coating properties.

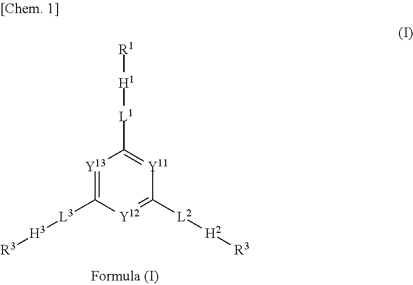

In the formula, Y¹¹, Y¹² and Y¹³ each independently represent a methine group or a nitrogen atom.

When each of Y¹¹, Y¹² and Y¹³ each is a methine group, the hydrogen atom of the methine group may be substituted with a substituent. Examples of the substituent of the methine group include an alkyl group, an alkoxy group, an aryloxy group, an acyl group, an alkoxycarbonyl group, an acyloxy group, an acylamino group, an alkoxycarbonylamino group, an alkylthio group, an arylthio group, a halogen atom, and a cyano group. Among those, preferred are an alkyl group, an alkoxy group, an alkoxycarbonyl group, an acyloxy group, a halogen atom and a cyano group; more preferred are an alkyl group having from 1 to 12 carbon atoms, an alkoxy group having from 1 to 12 carbon atoms, an alkoxycarbonyl group having from 2 to 12 carbon atoms, an acyloxy group having from 2 to 12 carbon atoms, a halogen atom and a cyano group.

Preferably, Y¹¹, Y¹² and Y¹³ are all methine groups, more preferably non-substituted methine groups, in terms of easiness in preparation of the compound.

In the formula, L¹, L² and L³ each independently represent a single bond or a bivalent linking group.

The bivalent linking group is preferably selected from —O—, —S—, —C(═O)—, —NR⁷—, —CH═CH—, —C≡C—, a bivalent cyclic group, and their combinations. R⁷ represents an alkyl group having from 1 to 7 carbon atoms, or a hydrogen atom, preferably an alkyl group having from 1 to 4 carbon atoms, or a hydrogen atom, more preferably a methyl, an ethyl or a hydrogen atom, even more preferably a hydrogen atom.

The bivalent cyclic group for L¹, L² and L³ is preferably a 5-membered, 6-membered or 7-membered group, more preferably a 5-membered or 6-membered group, or even more preferably a 6-membered group. The ring in the cyclic group may be a condensed ring. However, a monocyclic ring is preferred to a condensed ring for it. The ring in the cyclic group may be any of an aromatic ring, an aliphatic ring, or a heterocyclic ring. Examples of the aromatic ring are a benzene ring and a naphthalene ring. An example of the aliphatic ring is a cyclohexane ring. Examples of the heterocyclic ring are a pyridine ring and a pyrimidine ring. Preferably, the cyclic group contains an aromatic ring or a heterocyclic ring. According to the invention, the divalent cyclic group is preferably a divalent linking group consisting of a cyclic structure (but the cyclic structure may have any substituent(s)), and the same will be applied to the later.

Of the bivalent cyclic group represented by L¹, L² or L³, the benzene ring-having cyclic group is preferably a 1,4-phenylene group. The naphthalene ring-having cyclic group is preferably a naphthalene-1,5-diyl group or a naphthalene-2,6-diyl group. The pyridine ring-having cyclic group is preferably a pyridine-2,5-diyl group. The pyrimidine ring-having cyclic group is preferably a pyrimidin-2,5-diyl group.

The bivalent cyclic group for L¹, L² and L³ may have a substituent. Examples of the substituent are a halogen atom, a cyano group, a nitro group, an alkyl group having from 1 to 16 carbon atoms, an alkenyl group having from 2 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms.

In the formula, L¹, L² and L³ are preferably a single bond, *—O—CO—, *—CO—O—, *—CH═CH—, *—C≡C—, *-“bivalent cyclic group”-, *—O—CO—“bivalent cyclic group”-, *—CO—O-“bivalent cyclic group”-, *—CH═CH-“bivalent cyclic group”-, *—C≡C-“bivalent cyclic group”-, *-“bivalent cyclic group”-O—CO—, *-“bivalent cyclic group”-CO—O—, *-“bivalent cyclic group”-CH═CH—, or *-“bivalent cyclic group”-C≡C—. More preferably, they are a single bond, *—CH═CH—, *—C≡C—, *—CH═CH-“bivalent cyclic group”- or *—C≡C-“bivalent cyclic group”-, even more preferably a single bond. In the examples, “*” indicates the position at which the group bonds to the 6-membered ring of formula (IV) that contains Y¹¹, Y¹² and Y¹³.

In the formula, H¹, H² and H³ each independently represent the following formula (I-A) or (I-B):

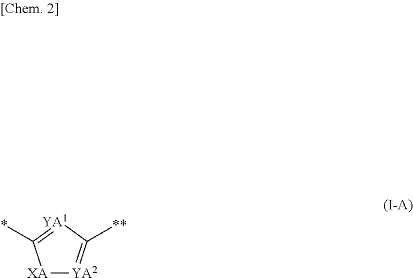

In formula (I-A), YA¹ and YA² each independently represent a methine group or a nitrogen atom;

XA represents an oxygen atom, a sulfur atom, a methylene group or an imino group;

* indicates the position at which the formula bonds to any of L¹ to L³; and

** indicates the position at which the formula bonds to any of R¹ to R³.

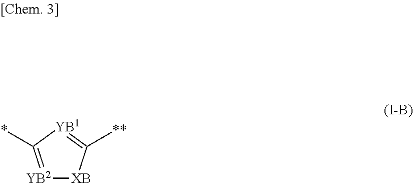

In formula (I-B), YB¹ and YB² each independently represent a methine group or a nitrogen atom;

XB represents an oxygen atom, a sulfur atom, a methylene group or an imino group;

* indicates the position at which the formula bonds to any of L¹ to L³; and

** indicates the position at which the formula bonds to any of R¹ to R³.

In the formula, R¹, R² and R³ each independently represent the following formula (I-R):

*-(-L²¹-Q²)ₙ₁-L²²-L²³-Q¹ (I-R)

In formula (I-R), * indicates the position at which the formula bonds to H¹, H² or H³ in formula (I).

L²¹ represents a single bond or a bivalent linking group. When L²¹ is a bivalent linking group, it is preferably selected from a group consisting of —O—, —S—, —C(═O)—, —NR⁷—, —CH═CH—, —C≡C—, and their combination. R⁷ represents an alkyl group having from 1 to 7 carbon atoms, or a hydrogen atom, preferably an alkyl group having from 1 to 4 carbon atoms, or a hydrogen atom, more preferably a methyl group, an ethyl group or a hydrogen atom, even more preferably a hydrogen atom.

In the formula, L²¹ is preferably a single bond, **—O—CO—, **—CO—O—, **—CH═CH— or **—C≡C— (in which ** indicates the left side of L²¹ in formula (I-R)). More preferably it is a single bond.

In the formula, Q² represents a bivalent cyclic linking group having at least one cyclic structure. The cyclic structure is preferably a 5-membered ring, a 6-membered ring, or a 7-membered ring, more preferably a 5-membered ring or a 6-membered ring, even more preferably a 6-membered ring. The cyclic structure may be a condensed ring. However, a monocyclic ring is preferred to a condensed ring for it. The ring in the cyclic ring may be any of an aromatic ring, an aliphatic ring, or a hetero ring. Examples of the aromatic ring are a benzene ring, a naphthalene ring, an anthracene ring, and a phenanthrene ring. An example of the aliphatic ring is a cyclohexane ring. Examples of the heterocyclic ring are a pyridine ring and a pyrimidine ring.

The benzene ring-having group for Q² is preferably a 1,4-phenylene group or a 1,3-phenylene group. The naphthalene ring-having group is preferably a naphthalene-1,4-diyl group, a naphthalene-1,5-diyl group, a naphthalene-1,6-diyl group, a naphthalene-2,5-diyl group, a naphthalene-2,6-diyl group, or a naphthalene-2,7-diyl group. The cyclohexane ring-having group is preferably a 1,4-cyclohexylene group. The pyridine ring-having group is preferably a pyridine-2,5-diyl group. The pyrimidine ring-having group is preferably a pyrimidin-2,5-diyl group. More preferably, Q² is a 1,4-phenylene group, a naphthalen-2,6-diyl group, or a 1,4-cyclohexylene group.

In the formula, Q² may have a substituent. Examples of the substituent are a halogen atom (e.g., fluorine atom, chlorine atom, bromine atom, iodine atom), a cyano group, a nitro group, an alkyl group having from 1 to 16 carbon atoms, an alkenyl group having from 1 to 16 carbon atoms, an alkynyl group having from 2 to 16 carbon atoms, a halogen atom-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. The substituent is preferably a halogen atom, a cyano group, an alkyl group having from 1 to 6 carbon atoms, a halogen atom-substituted alkyl group having from 1 to 6 carbon atoms, more preferably a halogen atom, an alkyl group having from 1 to 4 carbon atoms, a halogen atom-substituted alkyl group having from 1 to 4 carbon atoms, even more preferably a halogen atom, an alkyl group having from 1 to 3 carbon atoms, or a trifluoromethyl group.

In the formula, n1 indicates an integer of from 0 to 4. n1 is preferably an integer of from 1 to 3, or more preferably 1 or 2.

In the formula, L²² represents **—O—, **—O—CO—, **—CO—O—, **—O—CO—O—, **—S—, **—NH—, **—SO₂—, **—CH₂—, **—CH═CH— or **—C≡C—, and “*” indicates the site bonding to the Q² side. Preferably, L²² represents **—O—, **—O—CO—, **—CO—O—, **—O—CO—O—, **—CH₂—, **—CH═CH— or **—C≡C—, or more preferably, L²² represents **—O—, **—O—CO—, **—CO—O—, **—O—CO—O—, or **—CH₂—. When the above group has a hydrogen atom, then the hydrogen atom may be substituted with a substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

In the formula, L²³ represents a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with any other substituent. Examples of the substituent are a halogen atom, a cyano group, a nitro group, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms. The group substituted with the substituent improves the solubility of the compound of the formula (IV) in solvent, and therefore the composition can be readily prepared as a coating liquid.

In the formula, L²³ is preferably a linking group selected from a group consisting of —O—, —C(═O)—, —CH₂—, —CH═CH— and —C≡C—, and a group formed by linking two or more of these. L²³ preferably has from 1 to 20 carbon atoms, more preferably from 2 to 14 carbon atoms. Preferably, L²³ has from 1 to 16 (—CH₂—)'s, more preferably from 2 to 12 (—CH₂—)'s.

In the formula, Q¹ represents a polymerizable group or a hydrogen atom. In case where the compound of formula (IV) is used in producing optical films of which the retardation is required not to change by heat, such as optical compensatory films, Q¹ is preferably a polymerizable group. The polymerization for the group is preferably addition polymerization (including ring-cleavage polymerization) or polycondensation. In other words, the polymerizable group preferably has a functional group that enables addition polymerization or polycondensation. Examples of the polymerizable group are shown below.

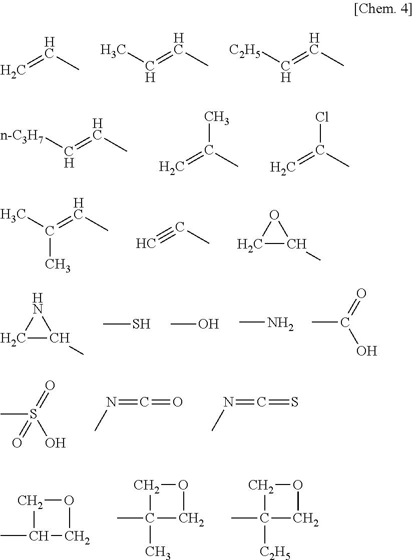

More preferably, the polymerizable group is addition-polymerizing functional group. The polymerizable group of the type is preferably a polymerizable ethylenic unsaturated group or a ring-cleavage polymerizable group.

Examples of the polymerizing ethylenic unsaturated group are the following (M-1) to (M-6):

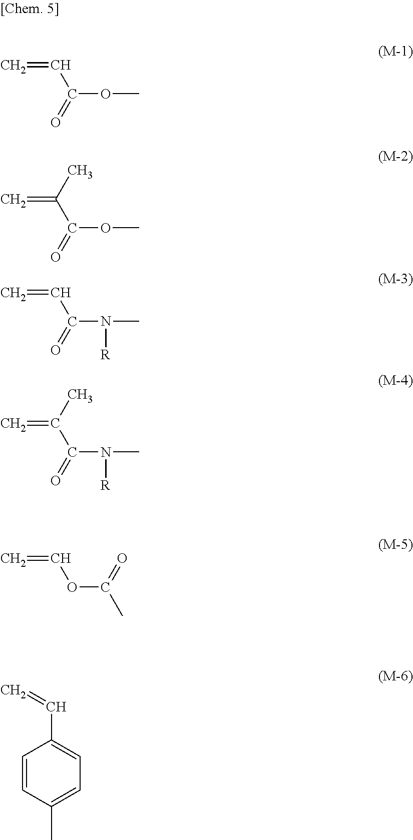

In formulae (M-3) and (M-4), R represents a hydrogen atom or an alkyl group. R is preferably a hydrogen atom or a methyl group.

Of formulae (M-1) to (M-6), preferred are formulae (M-1) and (M-2), and more preferred is formula (M-1).

The ring-cleavage polymerizable group is preferably a cyclic ether group, or more preferably an epoxy group or an oxetanyl group.

Among the compounds represented by formula (I), the compounds represented by formula (I′) are more preferable.

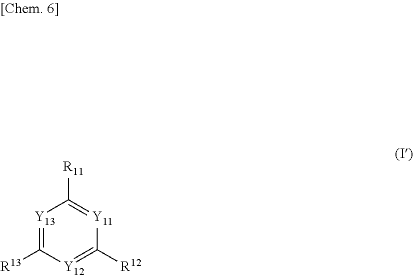

In the formula, Y¹¹, Y¹² and Y¹³ each independently represent a methine group or a nitrogen atom. Preferably, Y¹¹, Y¹² and Y¹³ are all methine groups, more preferably non-substituted methine groups.

In the formula, R¹¹, R¹² and R¹³ each independently represent the following formula represent the following formula (I′-A), (I′-B) or (I′-C). When the small wavelength dispersion of birefringence is needed, preferably, R¹¹, R¹² and R¹³ each represent the following formula (I′-A) or (I′-C), more preferably the following formula (I′-A). Preferably, R¹¹, R¹² and R¹³ are same (R¹¹=R¹²=R¹³)

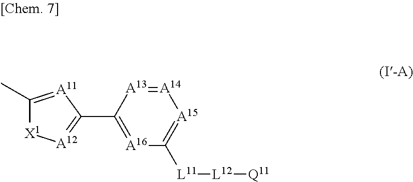

In formula (I′-A), A¹¹, A¹², A¹³, A¹⁴, A¹⁵ and A¹⁶ each independently represent a methine group or a nitrogen atom.

Preferably, at least one of A¹¹ and A¹² is a nitrogen atom; more preferably the two are both nitrogen atoms.

Preferably, at least three of A¹³, A¹⁴, A¹⁵ and A¹⁶ are methine groups; more preferably, all of them are methine groups. Non-substituted methine is more preferable.

Examples of the substituent that the methine group represented by A¹¹, A¹², A¹³, A¹⁴, A¹⁵ or A¹⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X¹ represents an oxygen atom, a sulfur atom, a methylene group or an imino group, but is preferably an oxygen atom.

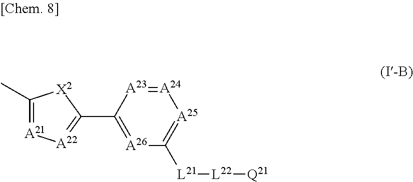

In formula (I′-B), A²¹, A²², A²³, A²⁴, A²⁵ and A²⁶ each independently represent a methine group or a nitrogen atom.

Preferably, at least either of A²¹ or A²² is a nitrogen atom; more preferably the two are both nitrogen atoms.

Preferably, at least three of A²³, A²⁴, A²⁵ and A²⁶ are methine groups; more preferably, all of them are methine groups.

Examples of the substituent that the methine group represented by A²³, A²⁴, A²⁵ or A²⁶ may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X² represents an oxygen atom, a sulfur atom, a methylene group or an imino group, but is preferably an oxygen atom.

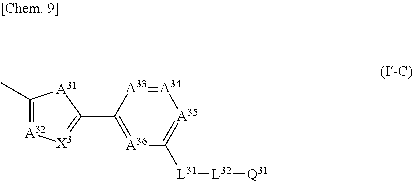

In formula (I′-C), A³¹, A³², A³³, A³⁴, A³⁵ and A³⁶ each independently represent a methine group or a nitrogen atom.

Preferably, at least either of A³¹ or A³² is a nitrogen atom; more preferably the two are both nitrogen atoms.

Preferably, at least three of A³³, A³⁴, A³⁵ and A³⁶ are methine groups; more preferably, all of them are methine groups.

When A³³, A³⁴, A³⁵ and A³⁶ are methine groups, the hydrogen atom of the methine group may be substituted with a substituent. Examples of the substituent that the methine group may have are a halogen atom (fluorine atom, chlorine atom, bromine atom, iodine atom), cyano, nitro, an alkyl group having from 1 to 16 carbon atoms, an alkenyl group having from 2 to 16 carbon atoms, an alkynyl group having from 2 to 16 carbon atoms, a halogen-substituted alkyl group having from 1 to 16 carbon atoms, an alkoxy group having from 1 to 16 carbon atoms, an acyl group having from 2 to 16 carbon atoms, an alkylthio group having from 1 to 16 carbon atoms, an acyloxy group having from 2 to 16 carbon atoms, an alkoxycarbonyl group having from 2 to 16 carbon atoms, a carbamoyl group, an alkyl group-substituted carbamoyl group having from 2 to 16 carbon atoms, and an acylamino group having from 2 to 16 carbon atoms. Of those, preferred are a halogen atom, a cyano group, an alkyl group having from 1 to 6 carbon atoms, a halogen-substituted alkyl group having from 1 to 6 carbon atoms; more preferred are a halogen atom, an alkyl group having from 1 to 4 carbon atoms, a halogen-substituted alkyl group having from 1 to 4 carbon atoms; even more preferred are a halogen atom, an alkyl group having from 1 to 3 carbon atoms, a trifluoromethyl group.

In the formula, X³ represents an oxygen atom, a sulfur atom, a methylene group or an imino group, but is preferably an oxygen atom.

L¹¹ in formula (I′-A), L²¹ in formula (I′-B) and L³¹ in formula (I′-C) each independently represent —O—, —O—CO—, —CO—O—, —O—CO—O—, —S—, —NH—, —SO₂—, —CH₂—, —CH═CH— or —C≡C—; preferably —O—, —O—CO—, —CO—O—, —O—CO—O—, —CH₂—, —CH═CH— or —C≡C—; more preferably —O—, —O—CO—, —CO—O—, —O—CO—O— or —C≡C—. L¹¹ in formula (I′-A) is especially preferable O—, —CO—O— or —C≡C— in terms of the small wavelength dispersion of birefringence; among these, —CO—O— is more preferable because the discotic nematic phase may be formed at a higher temperature. When above group has a hydrogen atom, then the hydrogen atom may be substituted with a substituent. Preferred examples of the substituent are a halogen atom, cyano, nitro, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. Especially preferred are a halogen atom, and an alkyl group having from 1 to 6 carbon atoms.

L¹² in formula (I′-A), L²² in formula (I′-B) and L³² in formula (I′-C) each independently represent a bivalent linking group selected from —O—, —S—, —C(═O)—, —SO₂—, —NH—, —CH₂—, —CH═CH— and —C≡C—, and a group formed by linking two or more of these. The hydrogen atom in —NH—, —CH₂— and —CH═CH— may be substituted with a substituent. Preferred examples of the substituent are a halogen atom, cyano, nitro, hydroxy, carboxyl, an alkyl group having from 1 to 6 carbon atoms, a halogen atom-substituted alkyl group having from 1 to 6 carbon atoms, an alkoxy group having from 1 to 6 carbon atoms, an acyl group having from 2 to 6 carbon atoms, an alkylthio group having from 1 to 6 carbon atoms, an acyloxy group having from 2 to 6 carbon atoms, an alkoxycarbonyl group having from 2 to 6 carbon atoms, a carbamoyl group, an alkyl group-substituted carbamoyl group having from 2 to 6 carbon atoms, and an acylamino group having from 2 to 6 carbon atoms. More preferred are a halogen atom, hydroxy and an alkyl group having from 1 to 6 carbon atoms; and especially preferred are a halogen atom, methyl and ethyl.

Preferably, L¹², L²² and L³² each independently represent a bivalent linking group selected from —O—, —C(═O)—, —CH₂—, —CH═CH— and —C≡C—, and a group formed by linking two or more of these.

Preferably, L¹², L²² and L³² each independently have from 1 to 20 carbon atoms, more preferably from 2 to 14 carbon atoms. Preferably, L¹², L²² and L³² each independently have from 1 to 16 (—CH₂—)'s, more preferably from 2 to 12 (—CH₂—)'s.

The number of carbon atoms constituting the L¹², L²² or L³² may influence both of the liquid crystal phase transition temperature and the solubility of the compound. Generally, the compound having the larger number of the carbon atoms has a lower phase transition temperature at which the phase transition from the discotic nematic phase (Nd phase) transits to the isotropic liquid occurs. Furthermore, generally, the solubility for solvent of the compound, having the larger number of the carbon atoms, is more improved.

Q¹¹ in formula (I′-A), Q²¹ in formula (I′-B) and Q³¹ in formula (I′-C) each independently represent a polymerizable group or a hydrogen atom. Preferably, Q¹¹, Q²¹ and Q³¹ each represent a polymerizable group. The polymerization for the group is preferably addition polymerization (including ring-cleavage polymerization) or polycondensation. In other words, the polymerizing group preferably has a functional group that enables addition polymerization or polycondensation. Examples of the polymerizable group are same as those exemplified above.

Specific examples of the compound represented by Formula (I) include, but not limited to, compounds described in paragraphs [0038] to [0069] in Japanese Patent Application Laid-Open Publication No. 2009-97002 and the following compounds.

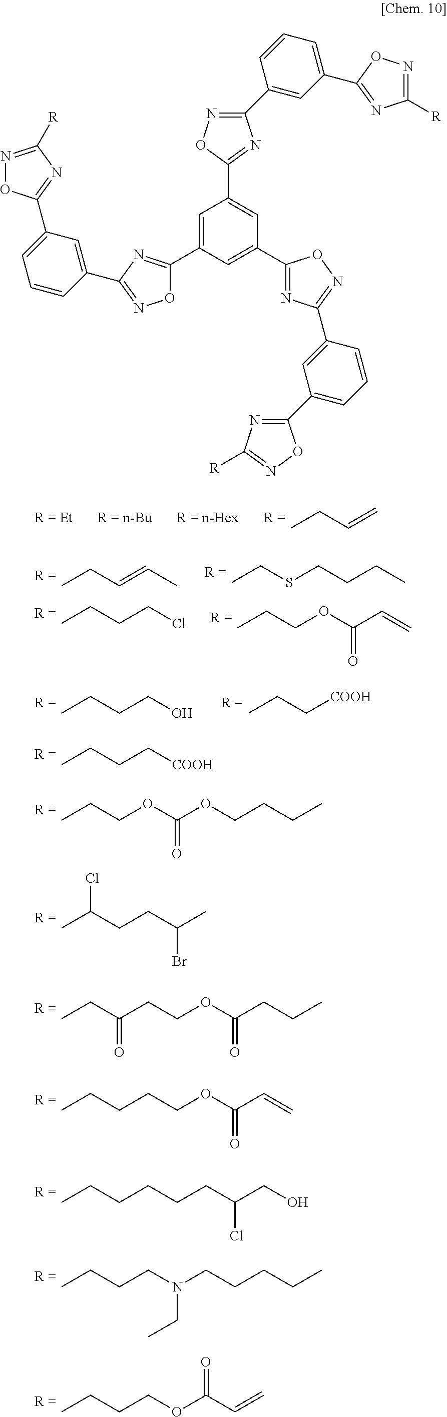

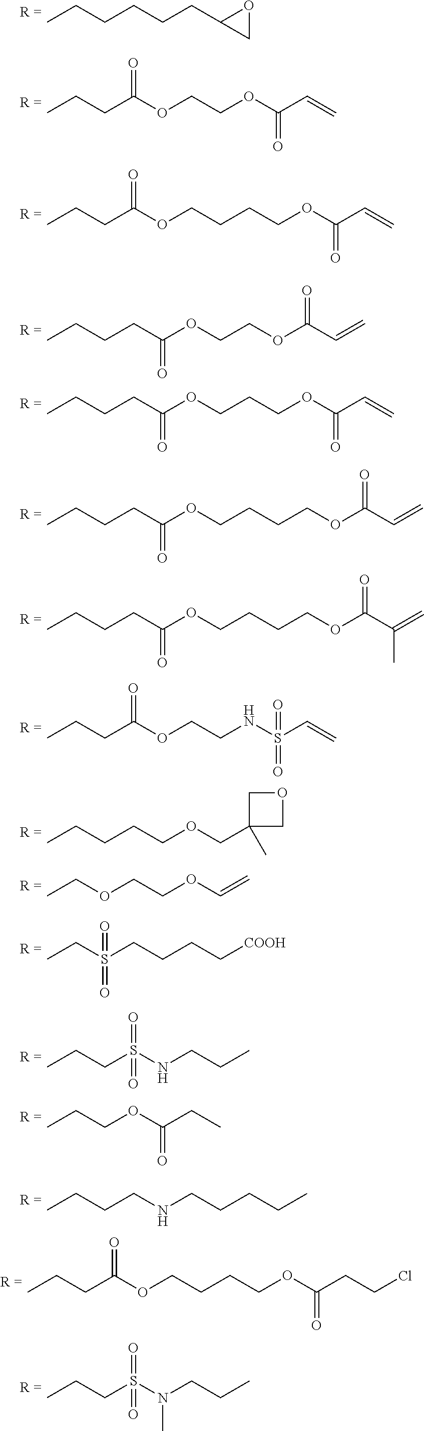

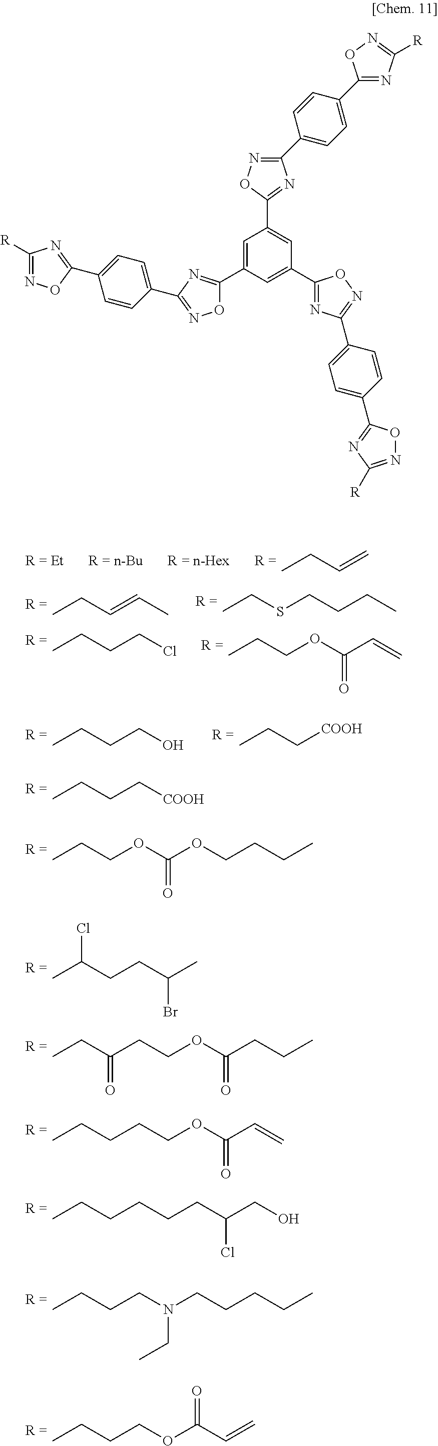

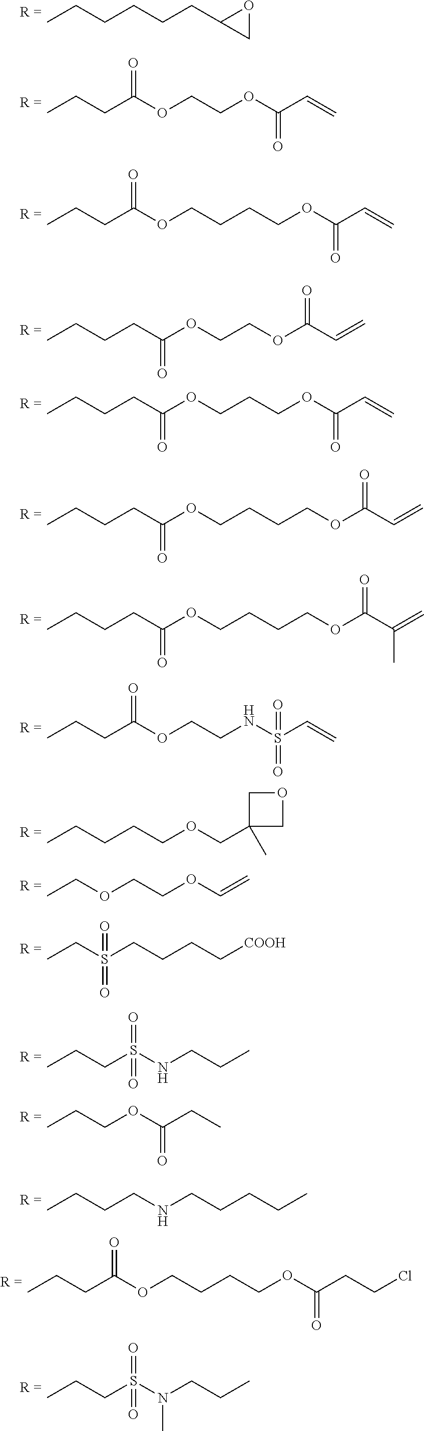

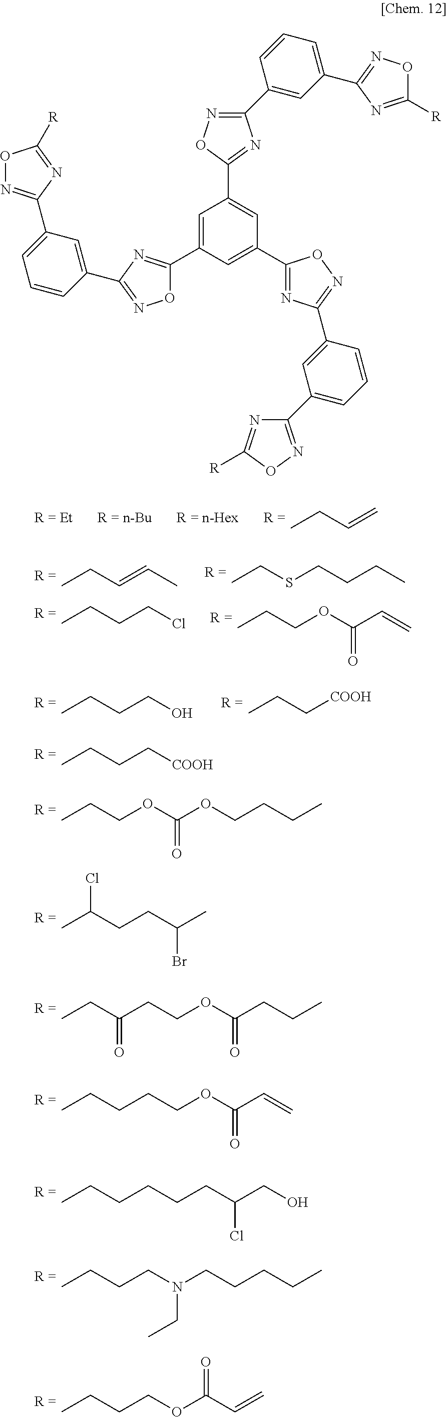

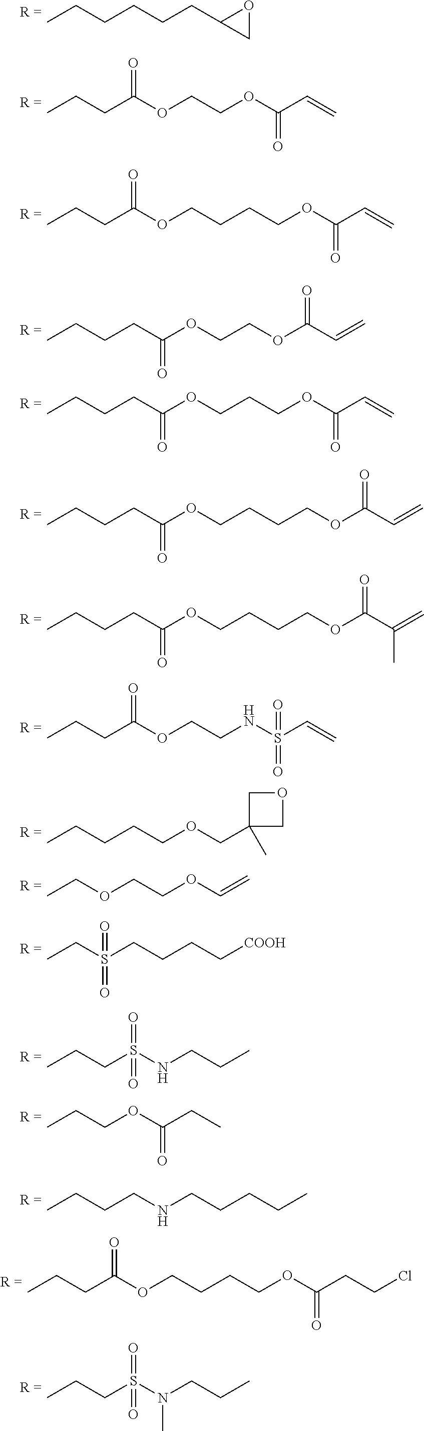

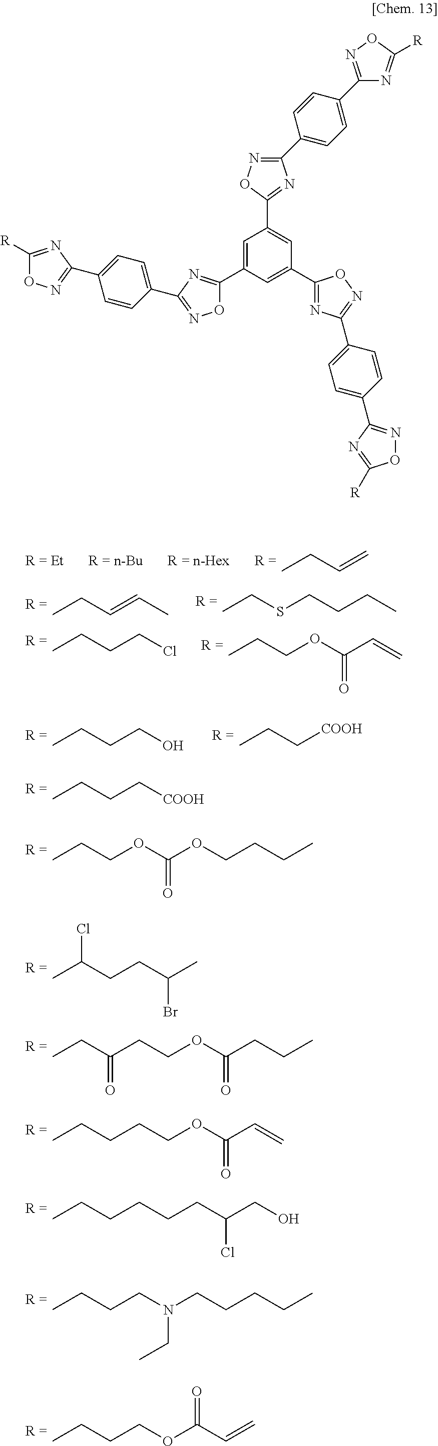

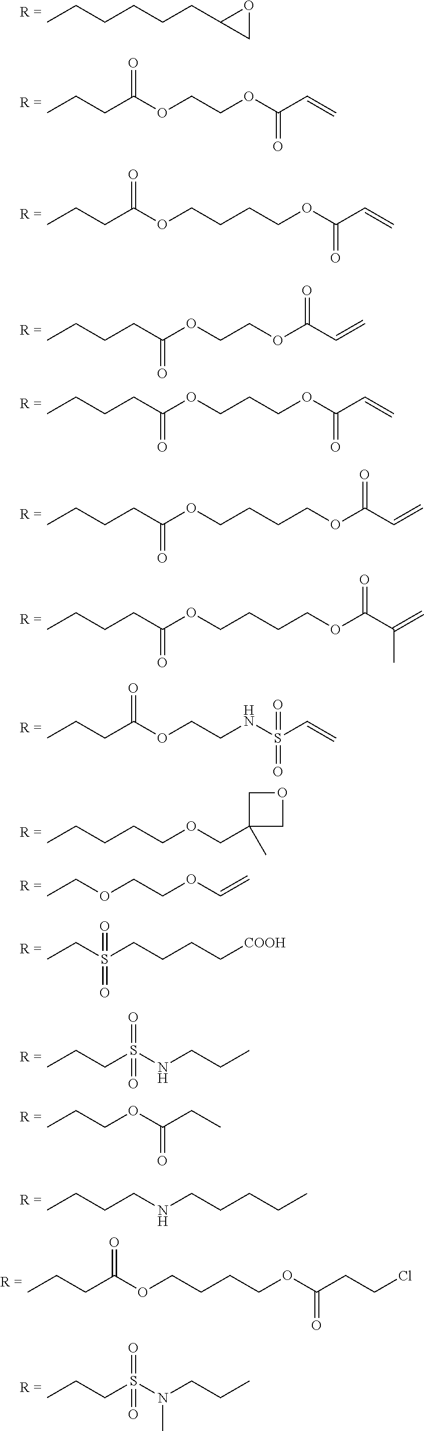

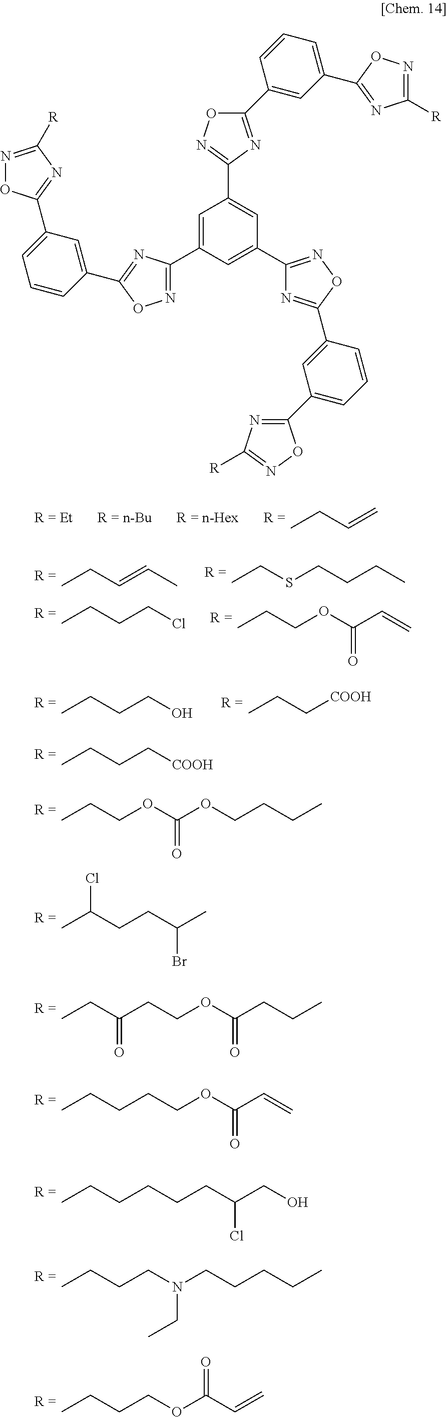

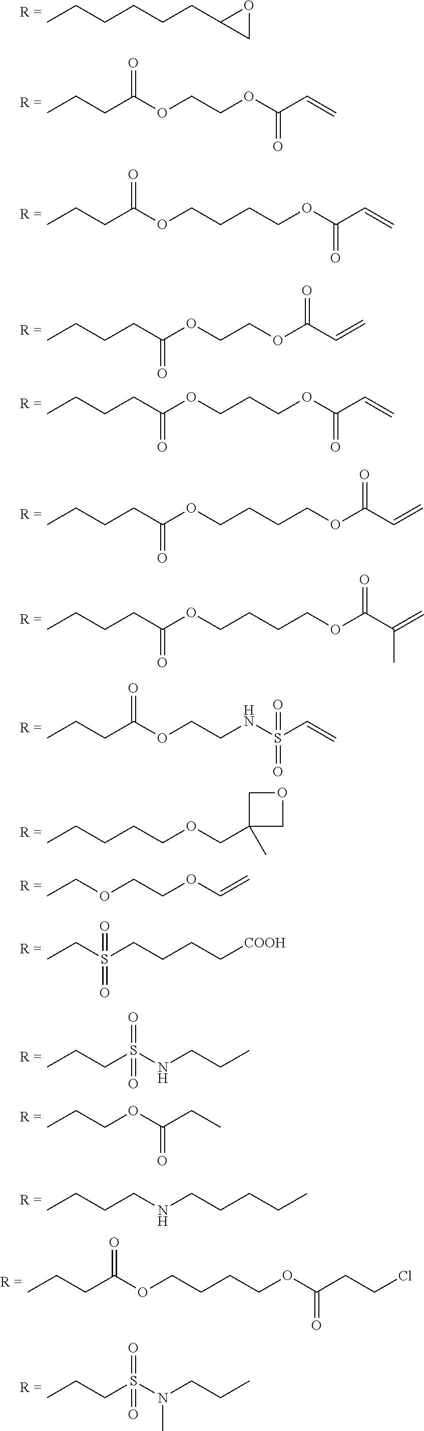

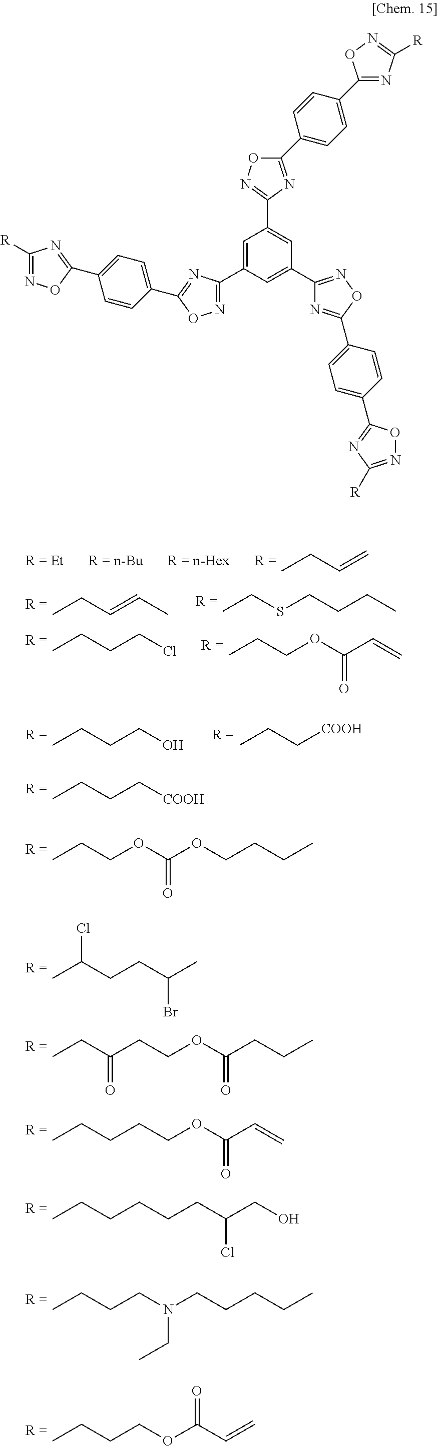

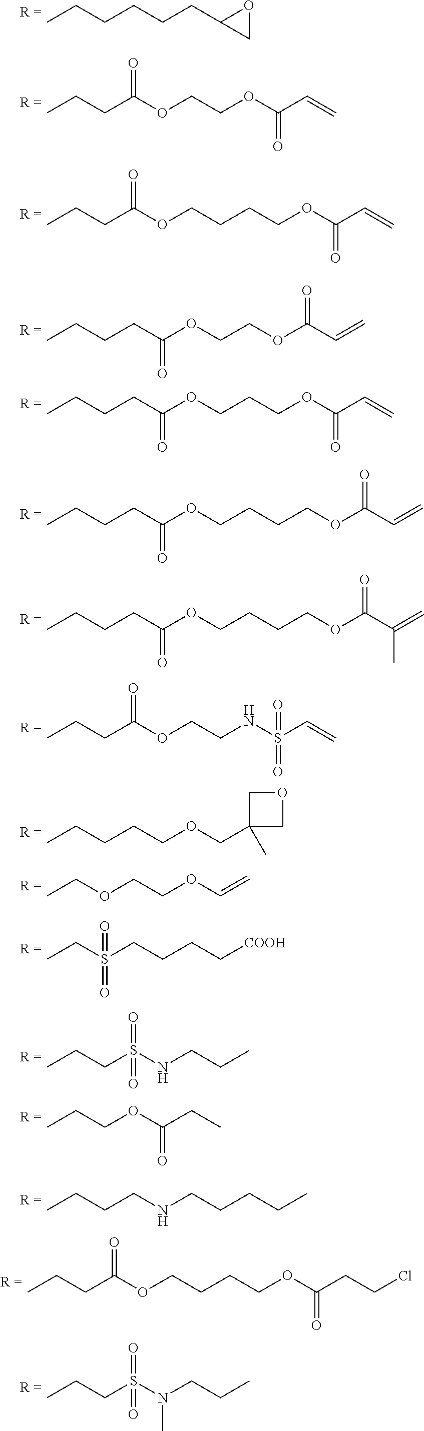

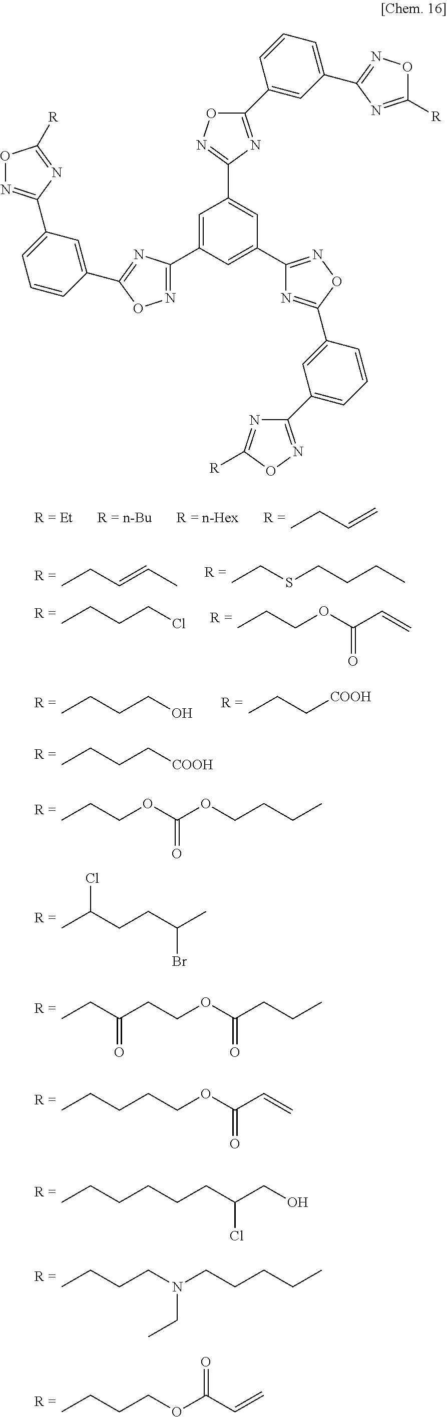

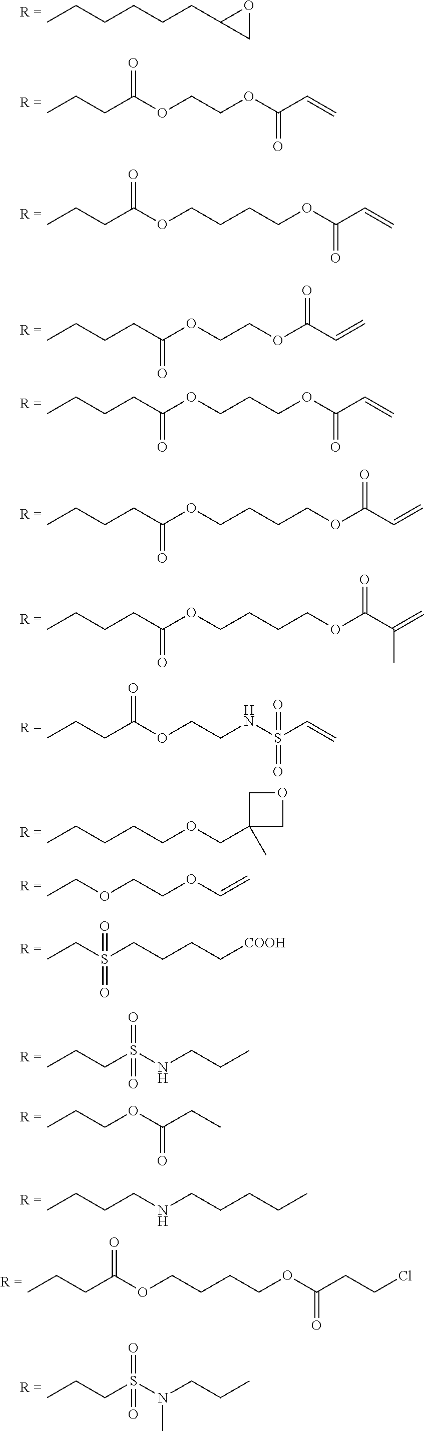

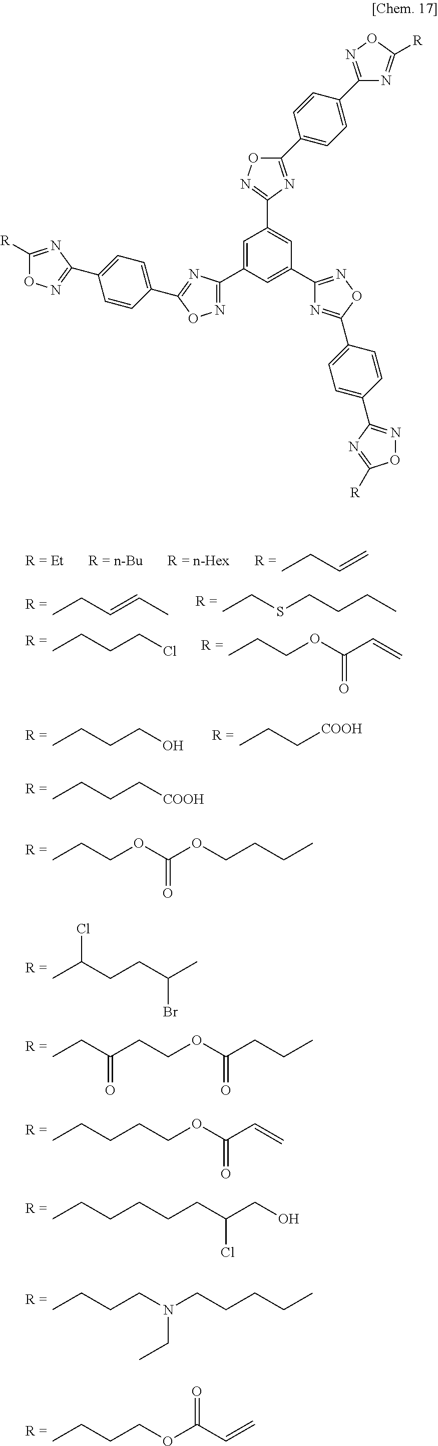

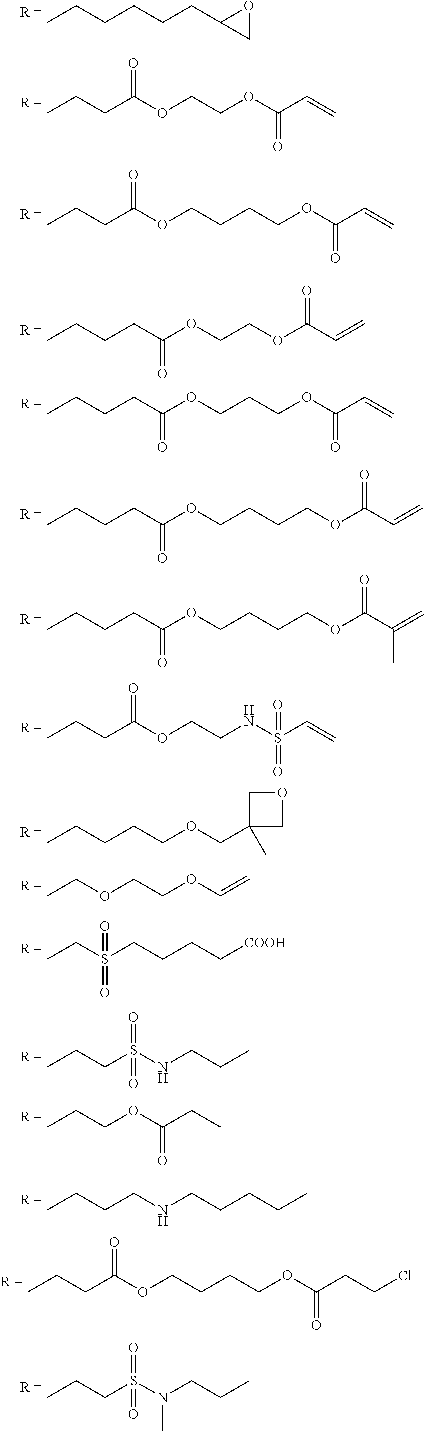

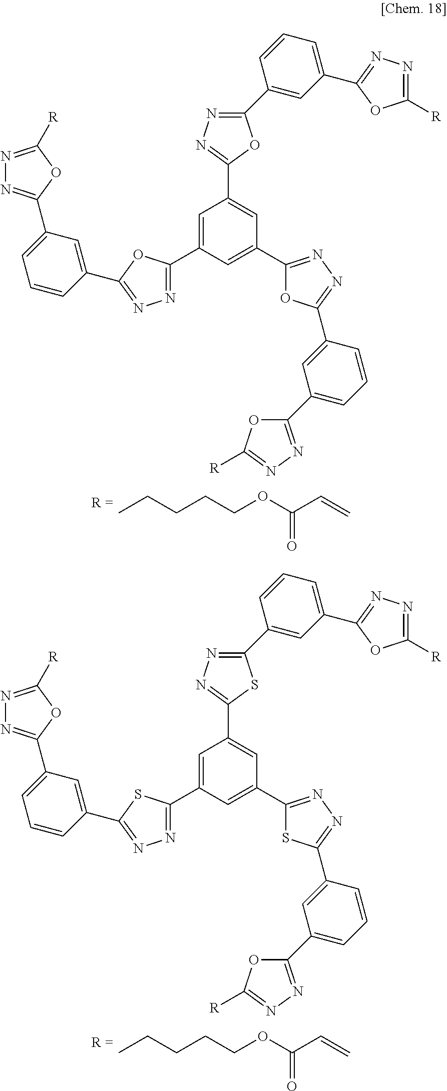

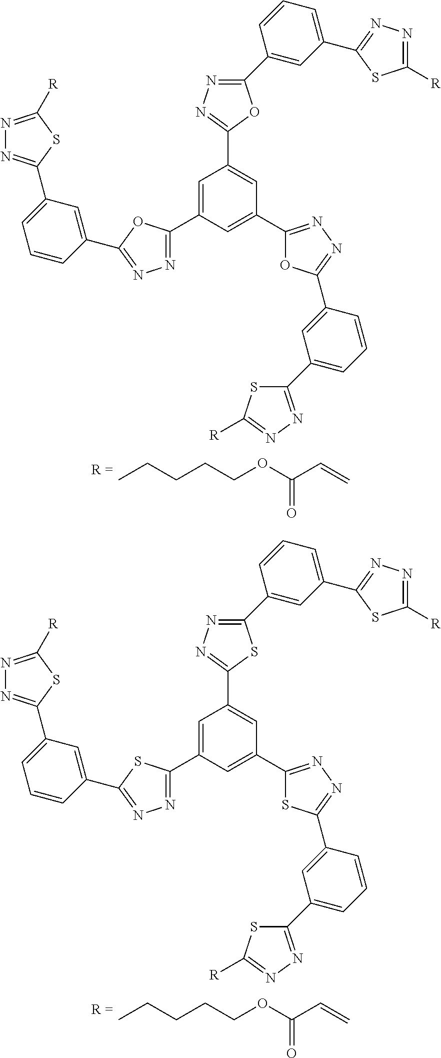

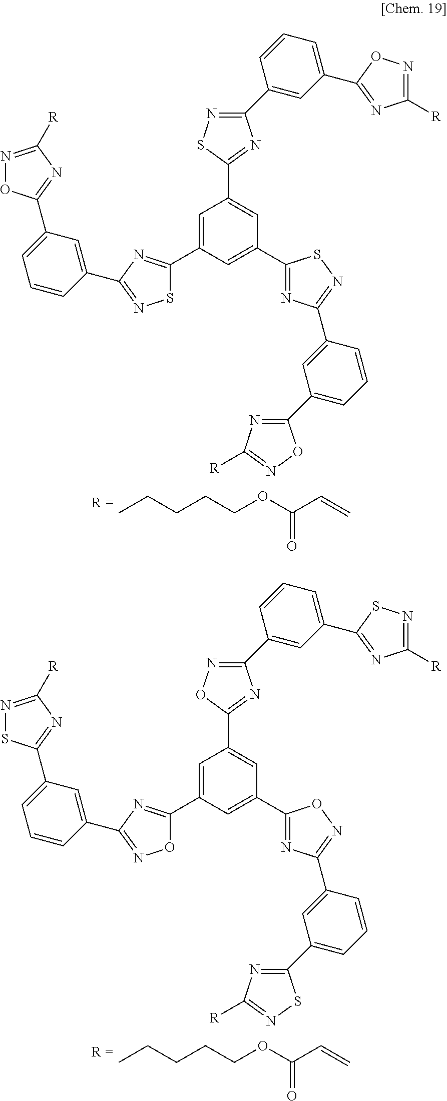

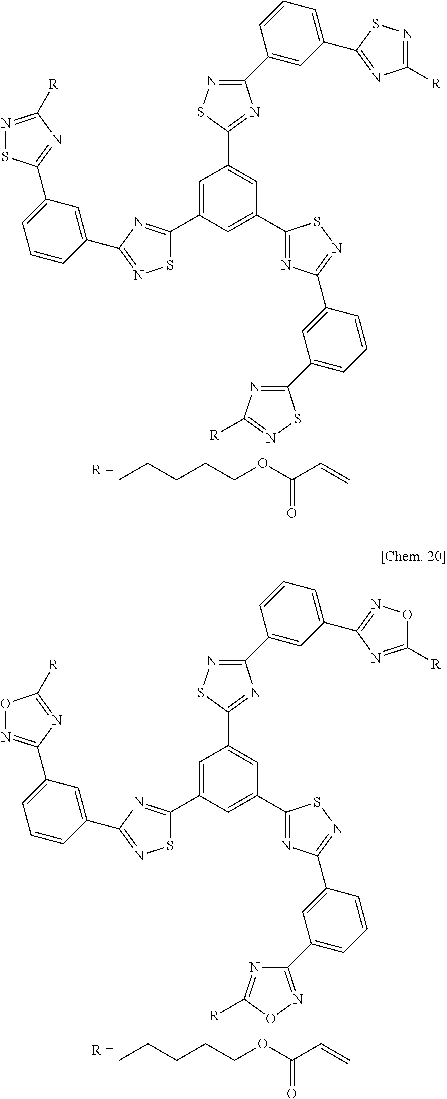

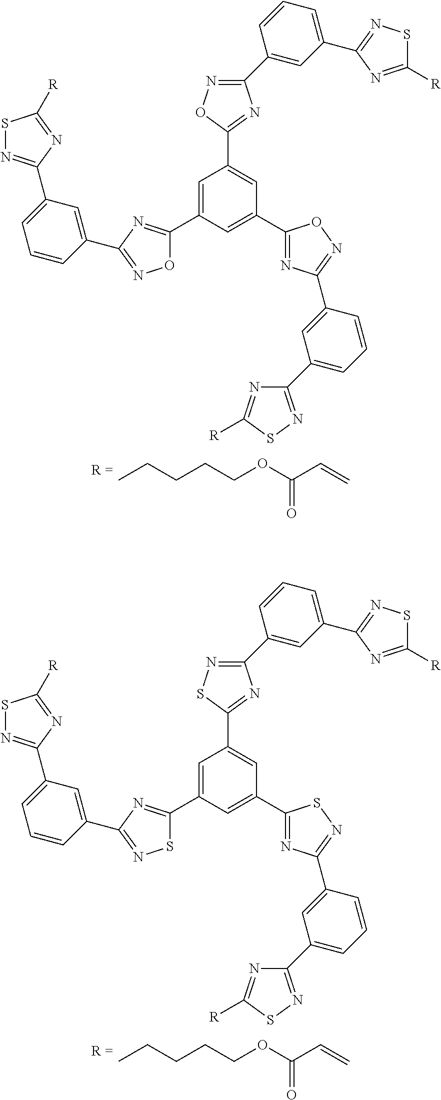

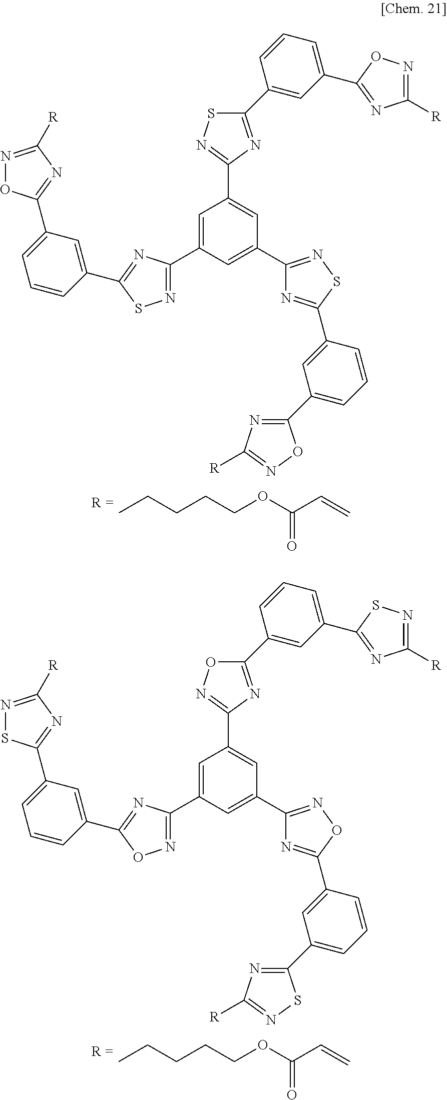

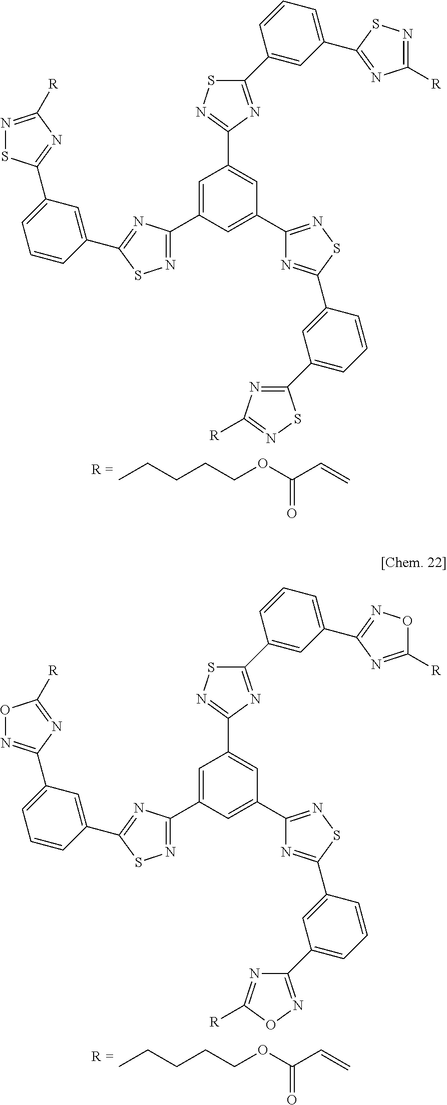

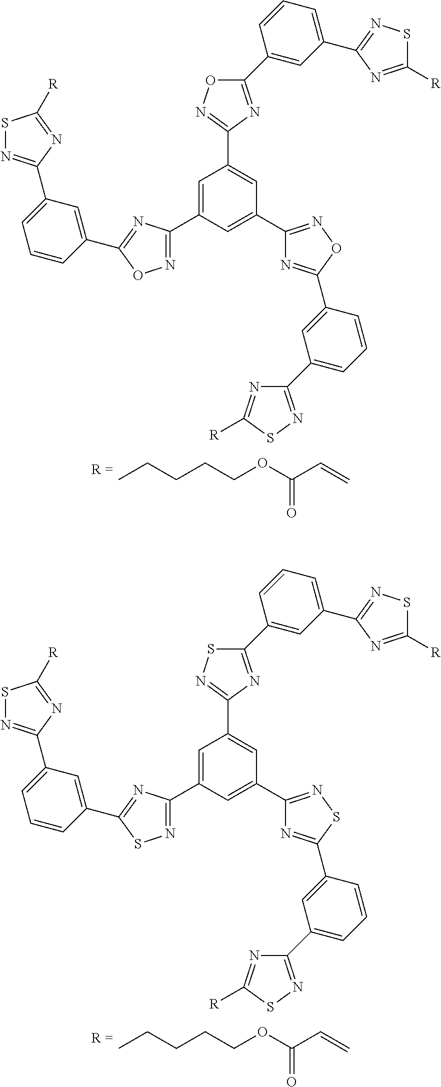

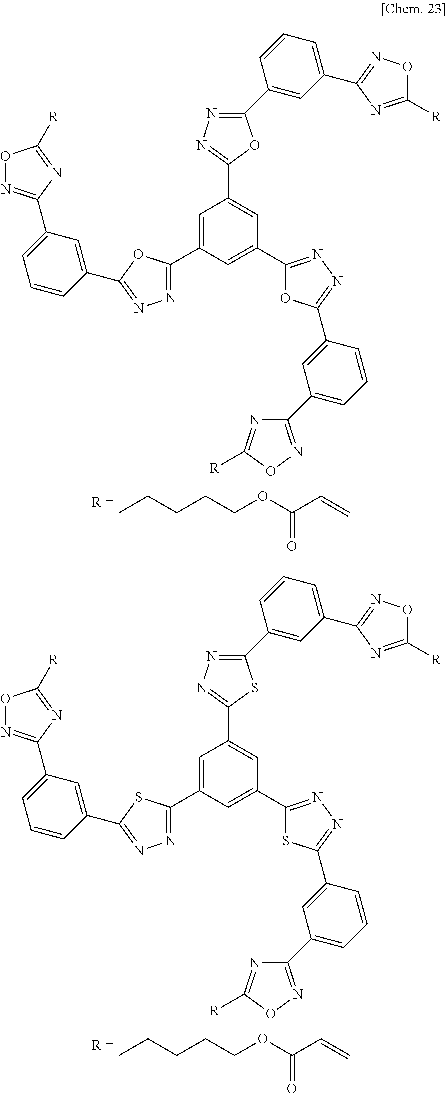

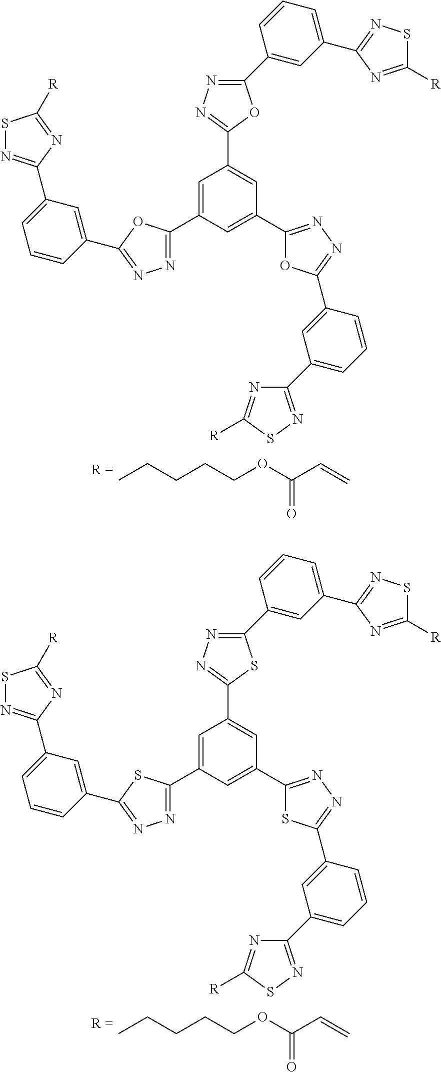

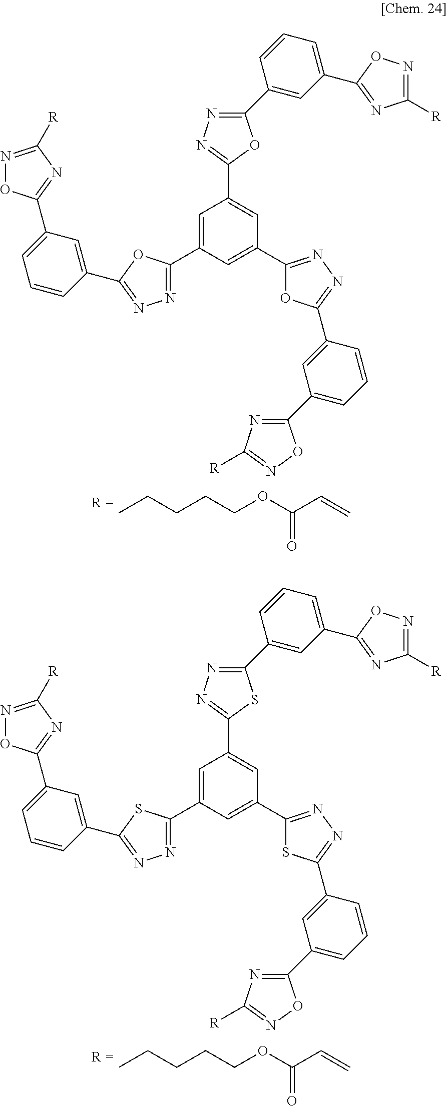

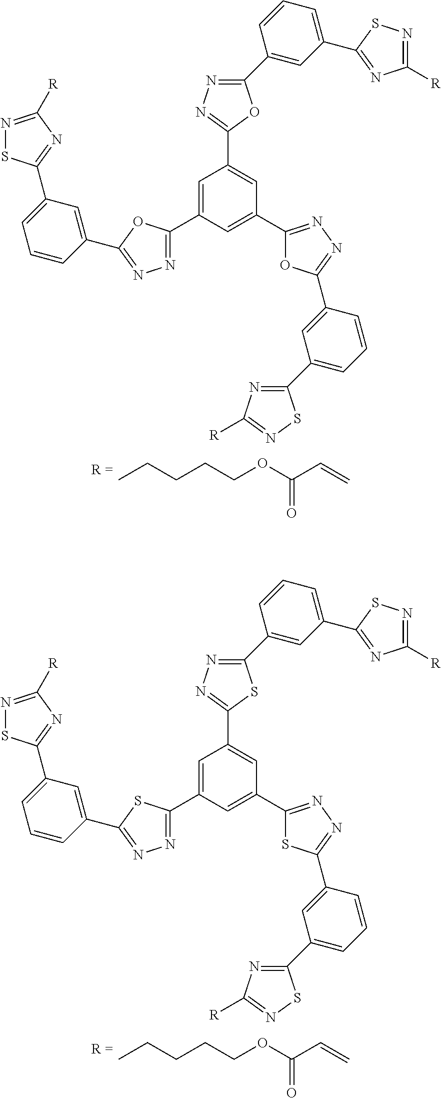

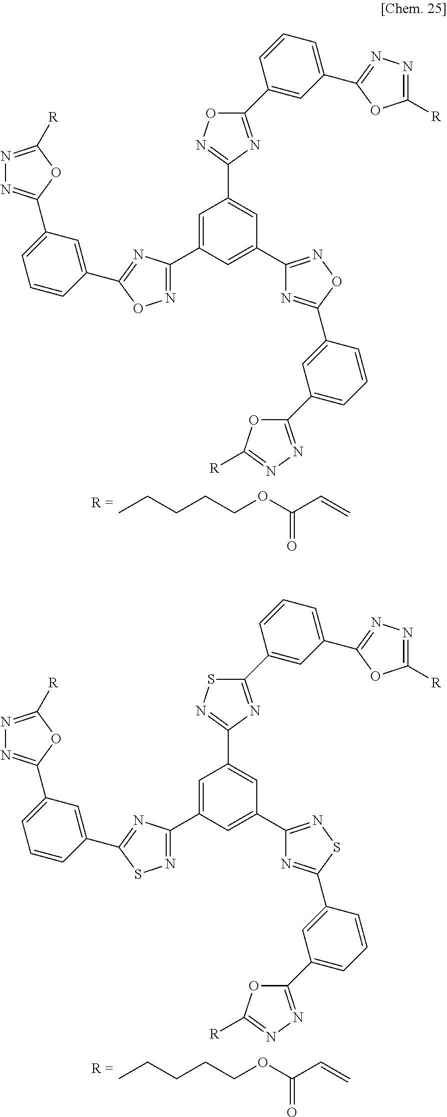

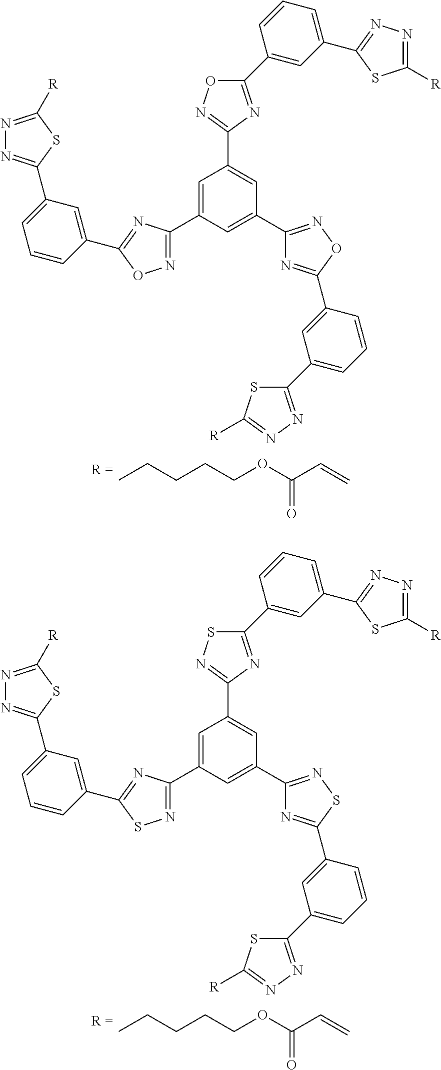

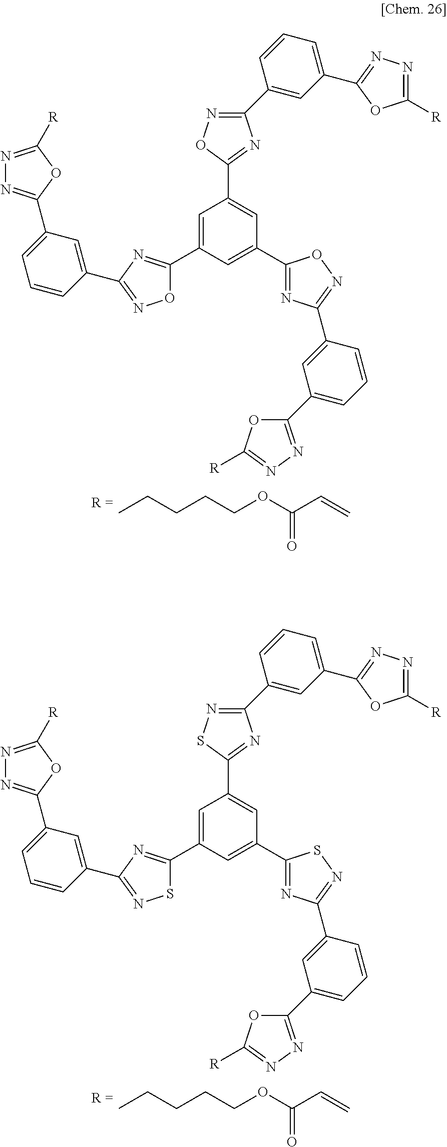

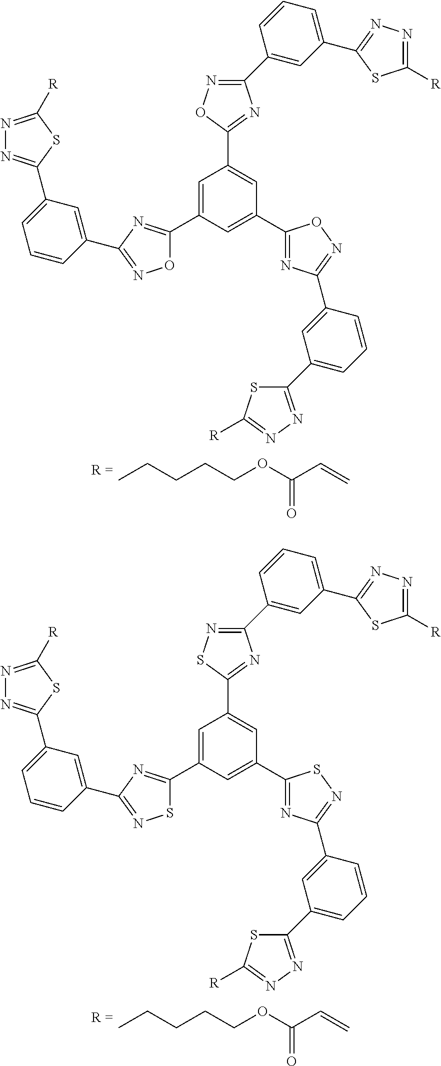

Examples of the discotic liquid crystal compound include also, but are not limited to, the triphenylene compounds described in JP-A-2007-108732, [0062]-[0067].

In this respect, one example composition that can reach the reverse hybrid alignment state described above is a composition comprising a tri-substituted benzene or triphenylene compound described above, at least one pyridinium compound represented by Formula (II) (more preferably, Formula (II′)) and at least one compound comprising a triazine ring group represented by Formula (III). The amount of the pyridinium compound added is preferably 0.5 to 3 parts by mass based on 100 parts by mass of the discotic liquid crystal compound. The amount of the compound comprising a triazine ring group added is preferably 0.2 to 0.4 parts by mass based on 100 parts by mass of the discotic liquid crystal compound.

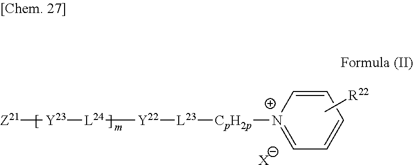

In the formula, L²³ and L²⁴ represent a divalent linking group respectively; R²² represents a hydrogen atom, non-substituted amino, or C₁₋₂₀ substituted amino; X represents an anion; Y²² and Y²³ represent a divalent linking group having a 5-membered or 6-membered ring as a part structure respectively; Z²¹ represents a monovalent group selected from the group consisting of a halogen-substituted phenyl, nitro-substituted phenyl, cyano-substituted phenyl, C₁₋₁₀ alkyl-substituted phenyl, C₂₋₁₀ alkoxy-substituted phenyl, C₁₋₁₂ alkyl, C₂₋₂₀ alkynyl, C₁₋₁₂ alkoxy, C₂₋₁₃ alkoxycarbonyl, C₇₋₂₆ aryloxycarbonyl and C₇₋₂₆ arylcarbonyloxy; p is an integer of from 1 to 10; and m is 1 or 2.

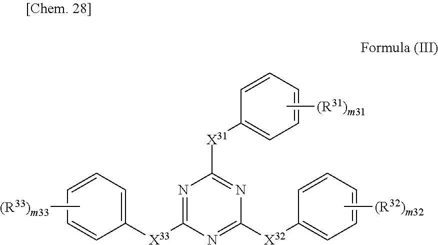

In the formula, R³¹, R³² and R³³ respectively represent an alkyl or alkoxy having a CF₃ group at the end thereof, provided that one or two or more carbon atoms, which are not adjacent to each other, in the alkyl (including the alkyl in the alkoxy) may be replaced with an oxygen or sulfur atom; X³¹, X³² and X³³ respectively represent a group formed by combining at least two bivalent groups selected from the group consisting of an alkylene, —CO—, —NH—, —O—, —S— and —SO₂—; and m31, m32 and m33 are respectively from 1 to 5. In formula (III), preferably, R³¹, R³² and R³³ each represent a group denoted by the following formula.

—O(CₙH₂ₙ)ₙ₁O(CₘH₂ₘ)ₘ₁—CₖF₂ₖ₊₁

In the formula, n and m are respectively from 1 to 3; n1 and m1 are respectively from 1 to 3; and k is from 1 to 10.

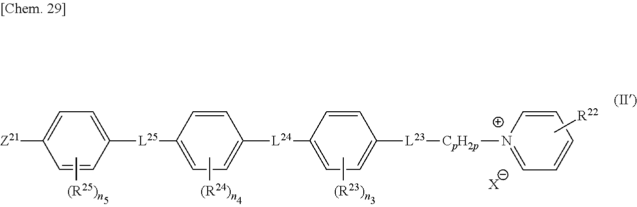

In formula (II′), each of the symbols has a same definition as that of each of the same symbols in formula (II); L²⁵ has a same definition as that of L²⁴; R²³, R²⁴ and R²⁵ respectively represent a C₁₋₁₂ alkyl; n3 is from 0 to 4; n4 is from 1 to 4; and n5 is from 0 to 4.

At least one polymerizable liquid crystal composition used for the formation of the optically-anisotropic layer described above is used, and one or more additives may be used with the composition. Example usable additives including an agent capable of controlling alignment at the air-interface, a repelling inhibitor, a polymerization initiator, and a polymerizable monomer will be described.

### Agent Capable of Controlling Alignment at the Air-Interface:

The composition may be aligned with the air-interface tilt angle at the air-interface. The tilt angle may be varied depending on the types of the liquid crystal compounds or the additives to be used in the composition, and thus, it may be necessary to be adjusted to the appropriate range depending on the purpose.

The tilt angle may be controlled by application of an external force such as an electric and magnetic fields or addition of any additive(s). Adding any additive(s) is preferable. Examples of such an additive include compounds having at least one, preferably two or more, substituted or non-substituted C₆₋₄₀ aliphatic group(s) in a molecule and compounds having at least one, preferably two or more, substituted or non-substituted C₆₋₄₀ aliphatic oligosiloxanoxy group(s) in a molecule. For example, the hydrophobic compounds having an effect of excluding-volume disclosed in JPA No. 2002-20363 can be used as an agent capable of controlling alignment at the air-interface.

And the polymers having a fluoro-aliphatic group described in JP-A-2009-193046 may have the same function, and may be added to the composition as the agent capable of controlling alignment at the air-interface.

An amount of the agent capable of controlling alignment at the air-interface to be added to the composition is preferably from 0.001 to 20% by mass, more preferably from 0.01 to 10% by mass, and much more preferably from 0.1 to 5% by mass with respect to the total mass of the composition (if the composition is a coating liquid or the like, the total mass is the solid total mass, and hereinafter, the term has the same meaning).

### Agent Capable of Reducing Defects (Hajiki):

Usually, any polymer may be added to the composition for preventing any defects occurring in a coating step. The polymer to be used is not limited unless adding the polymer to the composition would change the tilt angle or inhibit the alignment of the composition remarkably.

Examples of the polymer include those described in JPA No. 8-95030; and among these, cellulose acylates are preferable. Examples of the cellulose acylate which can be used in the invention include cellulose acetate, cellulose acetate propionate, hydroxy propyl cellulose and cellulose acetate butyrate.

In terms of avoiding inhibition of the alignment, the amount of the polymer to be added to the composition is preferably from 0.1 to 10% by mass, more preferably from 0.1 to 8% by mass, and much more preferably from 0.1 to 5% by mass with respect to the total mass of the composition.

### Polymerization Initiator:

The composition preferably comprises a polymerization initiator. The composition containing a polymerization initiator may be heated by the temperature at which the composition exhibits a liquid crystal phase, be polymerized and then be cooled, thereby to fix the alignment. Examples of the polymerization reaction include thermal polymerization reactions using a thermal polymerization initiator, photo-polymerization reactions using a photo-polymerization initiator and polymerizations with irradiation of electron beam. Photo-polymerization reactions and polymerizations with irradiation of electron beam are preferred in terms of avoiding deformation or degradation of the support or the like.

Examples of the photo-polymerization initiator include α-carbonyl compounds (those described in U.S. Pat. Nos. 2,367,661 and 2,367,670), acyloin ethers (those described in U.S. Pat. No. 2,448,828), α-hydrocarbon-substituted aromatic acyloin compounds (those described in U.S. Pat. No. 2,722,512), polynuclear quinone compounds (those described in U.S. Pat. Nos. 3,046,127 and 2,951,758), combinations of triarylimidazole dimer and p-aminophenyl ketone (those described in U.S. Pat. No. 3,549,367), acrydine and phenazine compounds (those described in Japanese Laid-Open Patent Publication No. S60-105667 and U.S. Pat. No. 4,239,850), and oxadiazole compounds (those described in U.S. Pat. No. 4,212,970).

An amount of the photo-polymerization initiator to be used is preferably from 0.01 to 20% by mass, or more preferable from 0.5 to 5% by mass, with respect to the composition.

### Polymerizable Monomer:

The composition may contain polymerizable monomer(s). The polymerizable monomer which can be used in the invention is not limited so far as the monomer is compatible with the liquid crystal compound and doesn't inhibit the alignment of the composition remarkably. The compound having any polymerizable ethylenic unsaturated group(s) such as vinyl, vinyloxy, acryloyl and methacryloyl is preferably used.

An amount of the polymerizable monomer to be added to the composition is preferably 0.5 to 50% by mass, and more preferably 1 to 30% by mass with respect to the total mass of the composition. Using any monomer having two or more reactive groups in a molecule is preferable in terms of improvement in the adhesion to the alignment layer.

The composition may be prepared as a coating liquid. The solvent which is used for preparing the coating liquid is desirably selected from organic solvents. Examples of the organic solvent include amides such as N,N-dimethylformamide, sulfoxides such as dimethylsulfoxide, heterocyclic compounds such as pyridine, hydrocarbons such as benzene or hexane, alkyl halides such as chloroform or dichloromethane, esters such as methyl acetate or butyl acetate, ketones such as acetone or methylethyl ketone and ethers such as tetrahydrofuran or 1,2-dimethoxyethane. Among these, esters and ketones are preferable; and ketones are more preferable. Plural types of organic solvents may be used in combination.

The optically anisotropic layer may be prepared by fixing the alignment of the composition. One example of the method for preparing the optically anisotropic layer is described below. However, the method is not limited to the method described below.

At first, the composition containing at least one polymerizable liquid crystal compound is applied to a surface of a support or an alignment layer formed on the support. If necessary, the composition is heated, and then aligned in a desired alignment state. Next, polymerization is carried out to fix the alignment state. In this way, the optically anisotropic layer can be produced. Examples of the additive which can be added to the composition include the agent capable of controlling alignment at the air-interface, the agent capable of reducing defects (hajiki), the polymerization initiator and the polymerizable monomer described above.

The coating liquid may be applied to a surface according to various techniques (e.g., wire bar coating, extrusion coating, direct gravure coating, reverse gravure coating and die coating).

For achieving a uniform alignment, an alignment layer is preferably used. The alignment layer prepared by rubbing a surface of a polymer layer (e.g., polyvinyl alcohol layer or polyimide layer) is preferable. Preferable examples of the alignment layer which can be used in the invention include the alignment layer formed of the acrylic acid-copolymer or the methacrylic acid-copolymer described in JP-A-2006-276203, [0130]-[0175]. By using the alignment layer, it is possible to prevent fluctuation of the liquid crystal compound and to achieve the high contrast.

Next, for fixing the alignment state, preferably, polymerization is carried out. Preferably, the composition containing a polymerization initiator is used and polymerization of the composition is carried out under irradiation with light. UV light is preferably used. The irradiation energy is preferably 10 mJ/cm² to 50 J/cm², more preferably 50 mJ/cm² to 800 mJ/cm². Irradiation may be carried out under heating to accelerate the photo-polymerization reaction. The concentration of oxygen in the atmosphere may influence the polymerization degree. Therefore, when the desired polymerization degree is not achieved during the polymerization under air, preferably, the concentration of oxygen is lowered by replacing air with nitrogen gas. The concentration of oxygen is preferably equal to or less than 10%, more preferably equal to or less than 7% and even more preferably equal to or less than 3%.

In the present invention, the meaning of “a fixed alignment state” is a typical and most preferable state, that is, a state maintaining the alignment; however, it is not limited to the typical state. More specifically, the meaning of “a fixed alignment state” indicates the state which has no fluidity at a temperature within the range from 0 to 50 degrees Celsius, or, under severer condition, from −30 to 70 degrees Celsius, is not changed depending on any external field or any external force and is stably kept. It is to be noted that after the optically anisotropic layer is formed by fixing the alignment state, the composition has any liquid crystallinity no longer. For example, the liquid crystal compound may lose any liquid crystallinity after it is polymerized by polymerization or crosslinking-reaction under irradiation with heat or light.

The thickness of the optically anisotropic layer is not limited, and generally, from about 0.1 to about 10 micrometers, or more preferably from about 0.5 to about 5 micro meters.

For preparing the optically anisotropic layer, any alignment layer may be used, and examples thereof include any alignment layers prepared by rubbing the surface of the layer containing polyvinyl alcohol or modified polyvinyl alcohol as a main ingredient.

### 2. Liquid Crystal Cell

In the present invention, two liquid crystal cells are used: one for image display and the other for polarization conversion. These liquid crystal cells may be in any mode, and can be used in different modes such as VA, IPS, OCB, TN, and STN modes.

The liquid crystal cell for image display will be selected in terms of display performance, while the polarization-converting liquid crystal cell will be selected in view of response speed since it make a response corresponding to right and left eye images, and preferred is a fast TN mode liquid crystal cell.

Any liquid crystal cell may have any structure. Typically, the liquid crystal cell has a structure comprising a pair of substrates which are disposed facing each other and a liquid crystal layer sandwiched between the pair of substrates, at least one of the pair of substrates having a voltage-applicable electrode. An alignment film for controlling alignment of the liquid crystal layer is also disposed, if desired. For the liquid crystal cell for image display, a color filter layer may be disposed to allow for color image display.

The liquid crystal cell includes any substrate that orients a liquid crystalline material for the liquid crystal layer in a specific alignment direction. Specifically, either a substrate that can align liquid crystals, or a substrate that lacks the alignment ability but is provided with an alignment film which can align liquid crystals may be used.

For the liquid crystal cell for image display, the preferred range of its Δnd (Δn refers to a birefringence of the liquid crystal layer, and d refers to the thickness of the liquid crystal layer) is similar to Δnd of each liquid crystal cell in a drive mode used for conventional 2D display devices. For the polarization-converting liquid crystal cell, its And has some influence on transmittance and brightness, the preferred range will be determined depending on the required crosstalk.

### 3. Polarizing Film

Any polarizing film can be used for the 3D display device of the present invention. Commonly used polarizing films can be used, for example, any of iodine-based polarizing films, dye polarizing films employing a dichroic dye, and polyene-based polarizing films. The iodine-based polarizing film and the dye polarizing films are prepared generally in such a way that a dichroic dye is adsorbed on polyvinyl alcohol and then the film is stretched.

In general, the polarizing film is laminated with protective films on both sides and is used as a polarizing plate. The protective film disposed between the liquid crystal cell for image display and each polarizing film or between the polarization-converting liquid crystal cell and each polarizing film is preferably an optically isotropic polymer film having a low Re and a low Rth, although such a polarizing plate may be used in the present invention. In certain embodiments where the retardation layer comprises or consists of a polymer film, the polymer film may function as a protective film for the first polarizing film.

### EXAMPLES

Paragraphs below will further specifically describe features of the present invention, referring to Examples and Comparative Examples. Any materials, amount of use, ratio, details of processing, procedures of processing and so forth shown in Examples may appropriately be modified without departing from the spirit of the present invention. Therefore, it is to be understood that the scope of the present invention should not be interpreted in a limited manner based on the specific examples shown below.

### (Formation of Polymer Films)

Cellulose acylates were synthesized by the methods described in Japanese Patent Application Laid-Open Publication Nos. 10-45804, and 08-231761, the degrees of substitution of the resulting cellulose acylates were measured. Specifically, sulfuric acid (7.8 parts by mass to 100 parts by mass of cellulose) was added as a catalyst, and then a carboxylic acid was added as a raw material for an acyl substituent. The mixture was subjected to acylation at 40° C. For the reaction, the kind and the amount of carboxylic acid used were adjusted to control the kind and the degree of substitution of the acyl group. After the acylation, ageing was conducted at 40° C. Low-molecular-weight components in the cellulose acylate were then washed out with acetone.

### (Preparation of Cellulose Acylate Solutions “C01” to “C05”)

The composition described below was loaded into a mixing tank and was stirred to dissolve each component. A cellulose acylate solution was prepared. The amount of the solvent used (methylene chloride and methanol) was appropriately adjusted so that each solution of cellulose acylate had a solids concentration of 22% by mass and a viscosity of 60 Pa·s.

-----------------------------------------------------------

Cellulose acetate (The degree of substitution shown in the table below) 100.0 parts by mass

Additives shown in the table below Amount shown in the table below

Methylene chloride 365.5 parts by mass

Methanol 54.6 parts by mass

-----------------------------------------------------------

The other solutions of cellulose acylate having a low degree of substitution were prepared as in solution “C01”, except that the kind and the degree of substitution of acyl group in the cellulose acylate used, the amount and the kind of the additive used varies as shown in the table below. The amount of the solvent used (methylene chloride and methanol) was appropriately adjusted so that each solution of cellulose acylate had a solids concentration of 22% by mass.

TABLE 1

| | Cellulose acylate | | Additive A | | Additive B | |
|---|---|---|---|---|---|---|
| | Degree | Additive | | Additive | | Additive |
| | of | amount | | amount | | amount |
| Solution | substi- | (parts by | | (parts by | | (parts by |
| No. | tution | mass) | Compound | mass) | Compound | mass) |
| C01 | 2.45 | 100 | A*1 | 19 | — | — |
| C02 | 2.8 | 100 | A*1 | 12 | — | — |
| C03 | 2.8 | 100 | A*1 | 10 | — | — |
| C04 | 2.8 | 100 | A*1 | 10 | B*2 | 2 |
| C05 | 2.8 | 100 | A*1 | 10 | B*2 | 7 |

*1: Compound A represents terephthalic acid/succinic acid/ethylene glycol/propylene glycol copolymer (monomer ratio [mole %] = 27.5/22.5/25/25). Compounds A are each a non-phosphate ester-based compound and also a retardation-expressing agent. The termini of the Compound A are terminated with acetyl groups.
*2: Compound B is of the following structural formula.

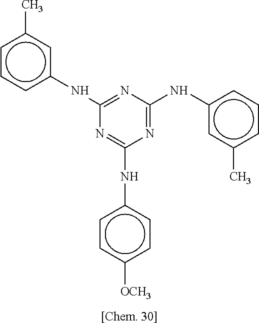

### (Formation of Cellulose Acylate-Based Film)

One or more solutions of cellulose acylate were shaped into a film by either casting or co-casting. The stretching temperature and the percent of stretch were shown in the table below.

### Casting (Formation of Films 5 to 11, and 14):

Any solution of cellulose acylate in the table described above was cast using a band stretching machine to form a film having a thickness of 60 μm. Subsequently, the resulting web (film) was peeled off from the band. The web was fastened with clips, and was stretched in the transverse direction with a tenter. The stretching temperature and the percent of stretch were shown in the table below. The clips were then released from the web. The web was dried at 130° C. for 20 minutes to prepare a film.

### Co-Casting (Formation of Films 1 to 4, 12, 13, and 15):

A solution C01 of cellulose acylate and a solution C02 of cellulose acylate were cast using a band stretching machine so as to form a core layer having a thickness of 56 μm and a skin layer A having a thickness of 2 μm, respectively. Subsequently, the resulting web (film) was peeled off from the band. The web was held with clips, and was stretched in the transverse direction with a tenter. The clips were then released from the web. The web was dried at 130° C. for 20 minutes to obtain a film. The stretching temperature and the percent of stretch were shown in the table below.

The structures, the stretching conditions, and the properties of the resulting films are shown in the table below.

TABLE 2

| | Structure of core layer | | Structure of skin layer A | | Stretching conditions | | Structure of film | | |
|---|---|---|---|---|---|---|---|---|---|
| | | Thickness | | Thickness | Temperature | | Thickness | Re(550)(nm) *1 | Rth(550) |
| Sample No. | Solution | (μm) | Solution | (μm) | (° C.) | Ratio | (μm) | (nm) | (nm) |
| Film 1 | C01 | 56 | C02 | 2 | 172 | 30% | 60 | 50 | 120 |
| Film 2 | C01 | 76 | C02 | 2 | — | 0% | 80 | 0 | 150 |
| Film 3 | C01 | 66 | C02 | 2 | 172 | 40% | 70 | 80 | 140 |
| Film 4 | C01 | 61 | C02 | 2 | — | 0% | 65 | 0 | 60 |
| Film 5 | C03 | 76 | — | — | 130 | 12% | 76 | 10 | 80 |
| Film 6 | C04 | 60 | — | — | 130 | 15% | 60 | 20 | 120 |
| Film 7 | C03 | 95 | — | — | 130 | 12% | 95 | 10 | 100 |
| Film 8 | C04 | 68 | — | — | 130 | 8% | 68 | 10 | 135 |
| Film 9 | C03 | 76 | — | — | 130 | 12% | 76 | 10 | 80 |
| Film 10 | C04 | 60 | — | — | 130 | 15% | 60 | 20 | 120 |
| Film 11 | C03 | 40 | — | — | 130 | 25% | 40 | 10 | 40 |
| Film 12 | C01 | 36 | C02 | 2 | 195 | 50% | 40 | 40 | 50 |
| Film 13 | C01 | 116 | C02 | 2 | 195 | 50% | 120 | 120 | 150 |
| Film 14 | C05 | 80 | — | — | 130 | 23% | 80 | 50 | 230 |
| Film 15 | C01 | 36 | C02 | 2 | 195 | 50% | 30 | 30 | 40 |

*1: In Table described above, Re was expressed as absolute value. Whether the Re is positive and negative is determined by the arrangement of the film in incorporating assembling into a display device (primarily, the relations with the transmission axis of the adjacent polarizing film).

### Formation of Retardation Film 16

“ZEONOR 1420R” in the pellet form from ZEON CORPORATION was used as a cyclic olefin resin. This resin had a glass transition point of 138° C. The cyclic resin ZEONOR 1420R in the pellet form was dried at 100° C. for 2 hours or more. The resin was melted at 260° C. and was shaped into a film. To elicit desired optical properties, free-end uniaxial stretching was carried out. The finished film had a thickness of 25 μm with an Re (550)=80 nm and an Rth (550)=60 nm.

### Example 1

### 1. Preparation of 3D Display Devices

### (1) Liquid Crystal Cell for Image Display

A vertical alignment (VA mode) liquid crystal cell assembled in a commercially available liquid crystal display (KDL-40J5000) was used as a liquid crystal cell for image display. Specifically, KDL-40J5000 was directly used to form an image display part including a liquid crystal cell for image display 10, and polarizing films 15 and 20 in FIG. 2.

A polyvinyl alcohol (PVA) film having a thickness of 80 μm was immersed in an aqueous iodine solution with an iodine concentration of 0.05% by mass at 30° C. for 60 seconds to be stained. The film was then immersed in an aqueous boric acid solution with a boric acid concentration of 4% by mass for 60 seconds, while being stretched in the machine direction 5 times its original length. Then, the film was dried at 50° C. for 4 minutes to prepare a polarizing film having a thickness of 20 μm.

A polymer film 1 was subjected to alkaline saponification, and the resulting film was then laminated on one side of the polarizing film with a polyvinyl alcohol adhesive to prepare a laminate 1.

Another polymer film 1 was subjected to alkaline saponification, and the resulting polymer film 1 was then laminated on the other side of the polarizing film with a polyvinyl alcohol adhesive. On top of the polymer film 1, CLEAR LR(CV film CV-LC from FUJIFILM Corporation), which is a low-reflection film, was laminated with a ready adhesive to produce a laminate 1′.

### (Polarization-Converting Liquid Crystal Cell)

A TN mode liquid crystal cell was prepared as a polarization-converting liquid crystal cell. Specifically, a liquid crystal material having a positive dielectric anisotropic layer was injected and sealed between substrates under vacuum to provide a liquid crystal cell including a liquid crystal layer with a Δnd·d of 400 nm. As the liquid crystal material, a positive dielectric anisotropic liquid crystal with a refractive index anisotropy, Δn=0.0854 (589 nm, 20° C.), Δ∈=about +8.5 was used. The liquid crystal cell had a twisted angle of 90°.

The laminate 1 was bonded onto the surface, adjacent to the liquid crystal cell, of one substrate in the resulting TN mode polarization-converting liquid crystal cell, while the laminate 1′ was bonded onto the surface, adjacent to the liquid crystal cell, of the other substrate. The laminate 1 was bonded into an E mode in view of the relationship to the polarization-converting liquid crystal cell, as shown in FIG. 3(b). The relationships between the respective axes of the laminated components were shown in the table below.

### (Preparation of 3D Display Devices)

A 3D display device having a structure shown in FIG. 2 was prepared by bonding the surface of the polarizing film that was the face of the polarization-converting liquid crystal cell on which the laminate 1 was bonded with the polarizing plate adjacent to the display face in the image display part. Here, lamination was carried out so that the transmission axis of the polarizing plate adjacent to the display face in the image display part was consistent with the transmission axis of the polarizing film in the laminate 1.

### 2. Preparation of Polarizing Glasses

Linear polarizing glasses were prepared and used as polarizing glasses in FIG. 2. When frames of these linear polarizing glasses were placed horizontally, the transmission axis of one of the frames was parallel, seen from the front, and the transmission axis of the other was orthogonal to the counterpart.

### Example 2

A 3D display device 2 was prepared as in Example 1, except that the laminate 1 was bonded into an O mode in view of the relationship to the polarization-converting liquid crystal cell.

### Example 3

Laminates 2 and 2′ were prepared as in laminates 1 and 1′ in Example 1, except that the film 1 was replaced with the film 2. A 3D display device 3 was prepared using the resulting laminates 2 and 2′ as in Example 1.

### Example 4

A 3D display device 4 was prepared as in Example 3, except that the laminate 2 was bonded into an O mode in view of the relationship to the polarization-converting liquid crystal cell, that is, in an arrangement shown in FIG. 3(a).

### Example 5

Laminates 3 and 3′ were prepared as in laminates 1 and 1′ in Example 1, except that the film 1 was replaced with the film 3. A 3D display device 5 was prepared as in Example 1, except that the resulting laminates 3 and 3′ were bonded into an O mode arrangement in view of the relationship to the polarization-converting liquid crystal cell.

### Example 6

A 3D display device 6 was prepared as in Example 5, except that the laminate 3 was laminated in an E mode in view of the relationship to the polarization-converting liquid crystal cell.

### Example 7

Laminates 4 and 4′ were prepared as in laminates 1 and 1′ in Example 1, except that the film 1 was replaced with the film 4. A 3D display device 7 was prepared using resulting laminates 4 and 4′ as in Example 1.

### Example 8

A 3D display device 8 was prepared as in Example 7, except that the laminate 4 was bonded into an O mode in view of the relationship to the polarization-converting liquid crystal cell.

### Example 9

Laminates 5 and 5′ were prepared as in laminates 1 and 1′ in Example 2, except that the film 1 was replaced with an optically-compensatory film 5 prepared by the process below, that the arrangement of the respective axes of the components was altered in the lamination as shown in the table below, and that an optically-anisotropic layer was added as described below. A 3D display device 9 was prepared using the resulting laminates 5 and 5′ as in Example 2. In this respect, the laminate 5 was prepared by bonding the surface of a polymer film 5 (the surface on which no optically-anisotropic layer was formed) with a polarizing film, while a laminate 5′ was prepared by bonding another polymer film 5 on the opposite side of the face of polarizing film on which the polymer film 5 was laminated to form a low-reflection film thereon. The laminates 5 and 5′ were bonded onto the polarization-converting liquid crystal cell such that the respective optically-anisotropic layers faced the liquid crystal cell.

### 1. Preparation of Alignment Film

On the prepared film 5, a coating solution of the following composition was applied into 28 mL/m² with a #16 wire bar coater. The coating was dried in hot air at 60° C. for 60 seconds, and then hot air at 90° C. for 150 seconds. The formed film was subjected to rubbing treatment in a direction parallel to the conveyance direction with a rubbing roller rotating at 500 revolutions per minute, to prepare an alignment film.

(Composition of Alignment Film Coating Solution)

| | | |
|---|---|---|
| Modified polyvinyl alcohol described below | 20 | parts by mass |
| Water | 360 | parts by mass |
| Methanol | 120 | parts by mass |
| Glutaraldehyde (crosslinker) | 1.0 | part by mass |

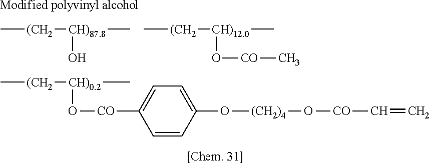

### 2. Preparation of Optically-Anisotropic Layer

A coating solution of the following composition was prepared.

The composition was dissolved in 98 parts by mass of methyl ethyl ketone to prepare a coating solution.

| | |
|---|---|
| Discotic liquid crystal compound (1) described below | 41.01 parts by mass |
| Ethylene oxide-modified trimethylolpropane triacrylate | 4.06 parts by mass |
| (V#360 from Osaka Organic Chemical Industry Ltd. | |
| Cellulose acetate butyrate | 0.34 parts by mass |
| (CAB551-0.2 from Eastman Chemical Company) | |
| Cellulose acetate butyrate | 0.11 parts by mass |
| (CAB531-1 from Eastman Chemical Company) | |
| Fluoroaliphatic group-containing polymer 1 described below | 0.13 parts by mass |
| Fluoroaliphatic group-containing polymer 2 described below | 0.03 parts by mass |
| Photopolymerization initiator (IRGACURE 907 from Ciba Geigy) | 1.35 parts by mass |
| Sensitizer (KAYACURE DETX from Nippon Kayaku Co., Ltd.) | 0.45 parts by mass |

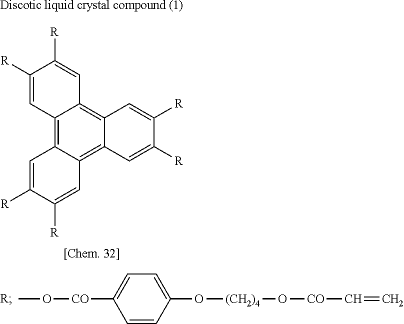

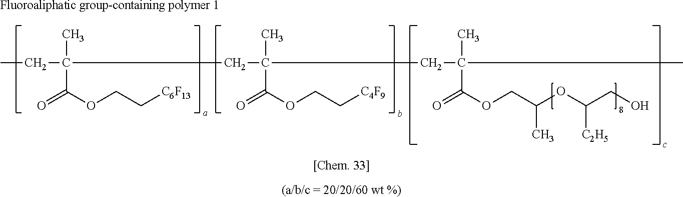

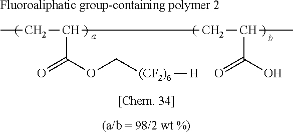

The coating solution described above was continuously applied on the alignment film surface of the roll film conveyed at 30 m/minute using a #3.2 wire bar. During a process of continuously heating from room temperature to 100° C., the solvent evaporated. After that, in a drying zone at 135° C. where air blowing at the discotic liquid crystal compound layer is adjusted to be parallel to the film conveyor direction at an air velocity of 1.5 m/sec at the film surface, the film was heated for about 90 seconds to align the discotic liquid crystal compound. The film was then transferred to a drying zone at 80° C. where at a surface temperature of the film of about 100° C., an ultraviolet radiation of an illuminance of 600 mW was irradiated for 4 seconds using an ultraviolet irradiation device (an ultraviolet lamp: output 160 W/cm, and emission length 1.6 m) to promote the cross-linking reaction, which fixes the discotic liquid crystal compound in the orientation state. The film was cooled to room temperature, and was cylindrically wound into a rolled film.

A retardation layer (an optically-compensatory film) was thus prepared.

### Example 10

Laminates 6 and 6′ were prepared as in Example 9, except that the film 5 was replaced with the film 6 as a support, and an optically-anisotropic layer was formed on the film 6 by the following process to prepare an optically-compensatory film 6, which was used in place of the optically-compensatory film 5. A 3D display device 10 was prepared using the resulting laminates 6 and 6′ as in Example 9.

### 1. Preparation of Alignment Film

On the prepared film 6, a coating solution of the following composition was applied into 28 mL/m² with a #16 wire bar coater. The coating was dried in hot air at 60° C. for 60 seconds, and then hot air at 90° C. for 150 seconds. The formed film was subjected to rubbing treatment in a direction parallel to the conveyance direction with a rubbing roller rotating at 500 revolutions per minute, to prepare an alignment film.

| | | |
|---|---|---|
| Modified polyvinyl alcohol described below | 20 | parts by mass |
| Water | 360 | parts by mass |
| Methanol | 120 | parts by mass |
| Glutaraldehyde (crosslinker) | 1.0 | parts by mass |

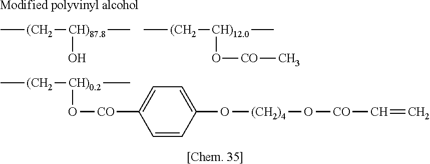

### 2. Preparation of Optically-Anisotropic Layer

A coating solution B having the following composition that contains a discotic liquid crystal compound was continuously applied on the alignment film surface prepared above using a #2.7 wire bar. The conveying speed (V) of the film was set at 36 m/min. For evaporation of the solvent in the coating solution and ageing of the aligned discotic liquid crystal compound, the coating was heated in hot air at 120° C. for 90 seconds. Subsequently, the film was irradiated with ultraviolet rays at 80° C. to fix the alignment of the liquid crystal compound, which forms an optically-anisotropic layer. This prepares an optically-compensatory film.

### Composition of the Coating Solution (B) for the Optically-Anisotropic Layer

| | | |
|---|---|---|
| Discotic liquid crystal compound described below | 100 | parts by mass |
| Photopolymerization initiator (IRGACURE 907 from Ciba Geigy) | 3 | parts by mass |
| Sensitizer (KAYACURE DETX from Nippon Kayaku Co., Ltd.) | 1 | part by mass |
| Pyridinium salt described below | 1 | part by mass |
| Fluoropolymer (FP2) described below | 0.4 | part by mass |
| Methyl ethyl ketone | 252 | parts by mass |

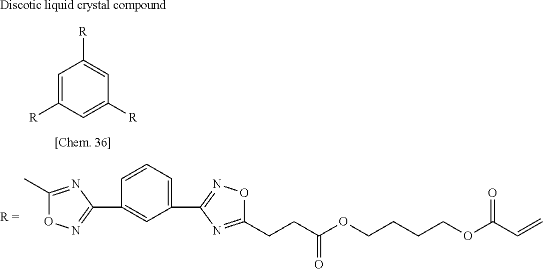

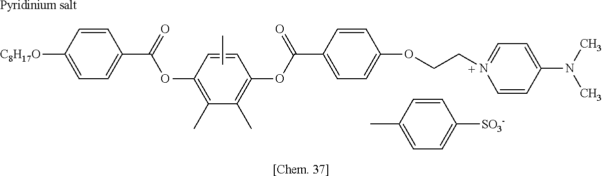

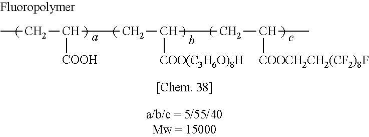

### Example 11

A 3D display device 11 was prepared as in Example 1, except that the liquid crystal cell including a liquid crystal layer with a Δn·d of 400 nm was replaced with a liquid crystal cell including a liquid crystal layer with a Δn·d of 460 nm.

### Example 12

A 3D display device 12 was prepared as in Example 2, except that the liquid crystal cell including a liquid crystal layer with a Δn·d of 400 nm was replaced with a liquid crystal cell including a liquid crystal layer with a Δn·d of 460 nm.

### Example 13

A 3D display device 13 was prepared as in Example 9, except that the film 5 was replaced with the film 7 as a support, and the liquid crystal cell including a liquid crystal layer with a Δn·d of 400 nm was replaced with a liquid crystal cell including a liquid crystal layer with a Δn·d of 460 nm.

### Example 14

A 3D display device 14 was prepared as in Example 10, except that the film 6 was replaced with the film 8 as a support, and the liquid crystal cell including a liquid crystal layer with a Δn·d of 400 nm was replaced with a liquid crystal cell including a liquid crystal layer with a Δn·d of 460 nm.

### Example 15

A 3D display 15 was prepared as in Example 1, except that the VA mode liquid crystal cell (the liquid crystal cell for image display), off which the polarizing plate adjacent to the display face in the image display part was peeled, was bonded with the surface of the polarizing film that was the face of the polarization-converting liquid crystal cell on which the laminate 1 was bonded. A 3D display 15 having the structure shown in FIG. 1 was thereby prepared.

### Example 16

A 3D display 16 was prepared as in Example 9, except that the VA mode liquid crystal cell (the liquid crystal cell for image display) from which the polarizing plate adjacent to the display face in the image display part was removed was bonded with the surface of the polarizing film that was the face of the polarization-converting liquid crystal cell on which the laminate 1 was bonded, and the film 5 was replaced with the film 9 as a support. A 3D display 16 having the structure shown in FIG. 1 was thereby prepared.

### Example 17

A 3D display 17 was prepared as in Example 10, except that the VA mode liquid crystal cell (the liquid crystal cell for image display) from which the polarizing plate adjacent to the display face in the image display part was removed was bonded with the surface of the polarizing film that was the face of the polarization-converting liquid crystal cell on which the laminate 1 was bonded, and the film 6 was replaced with the film 10 as a support. A 3D display 17 having the structure shown in FIG. 1 was thereby prepared.

### Example 18

A 3D display 18 was prepared as in Example 11, except that the VA mode liquid crystal cell (the liquid crystal cell for image display) from which the polarizing plate adjacent to the display face in the image display part was removed, was bonded with the surface of the polarizing film that was the face of the polarization-converting liquid crystal cell on which the laminate 1 was bonded. A 3D display 18 having the structure shown in FIG. 1 was thereby prepared.

### Example 19

A 3D display 19 was prepared as in Example 13, except that the VA mode liquid crystal cell (the liquid crystal cell for image display) from which the polarizing plate adjacent to the display face in the image display part was removed, was bonded with the surface of the polarizing film that was the face of the polarization-converting liquid crystal cell on which the laminate 1 was bonded. A 3D display 19 having the structure shown in FIG. 1 was thereby prepared.

### Example 20

A 3D display 20 was prepared as in Example 14, except that the VA mode liquid crystal cell (the liquid crystal cell for image display) from which the polarizing plate adjacent to the display face in the image display part was removed, was bonded with the surface of the polarizing film that was the face of the polarization-converting liquid crystal cell on which the laminate 1 was bonded. A 3D display 20 having the structure shown in FIG. 1 was thereby prepared.

### Example 21

A 3D display device 21 was prepared as in Example 15, except that without the laminate 1′ was not used and the laminate 1 was bonded into an O mode in view of the relationship to the polarization-converting liquid crystal cell.

### Example 22

Laminates 16 and 16′ were prepared as in Example 9, except that the film 5 was replaced with the film 16 as a support, and an optically-anisotropic layer was formed on the film 16 as in Example 9 to prepare an optically-compensatory film 16, which was used in place of the optically-compensatory film 5. A 3D display device 22 was prepared using the resulting laminates 16 and 16′ as in Example 9.

### Example 23

An alignment film was prepared as in Example 9, except that the coating film formed on the prepared film 5 was subjected to rubbing treatment in a direction at 45 degrees to the conveyance direction with a rubbing roller rotating at 500 revolutions per minute. Laminates 17 and 17′ were then prepared as in Example 9, except that an optically-anisotropic layer was formed to prepare an optically-compensatory film 17 and the optically-compensatory film 5 was replaced with the resulting film 17.

The laminate 17 was bonded onto the surface, adjacent to the liquid crystal cell, of one substrate in the TN mode polarization-converting liquid crystal cell, while the laminate 17′ was bonded onto the surface, adjacent to the liquid crystal cell, of the other substrate. The laminate 17 was bonded into the arrangement shown in FIG. 3(c) to prepare a 3D display device 23.

### Example 24

An alignment film was prepared as in Example 9, except that the film 5 was replaced with the film 16 as a support, and the coating film formed on the prepared film 5 was subjected to rubbing treatment in a direction at 45 degrees to the conveyance direction with a rubbing roller rotating at 500 revolutions per minute. Laminates 18 and 18′ were then prepared as in Example 9, except that an optically-anisotropic layer was formed to prepare an optically-compensatory film 18, and the optically-compensatory film 5 was replaced with the resulting film 18. The laminate 18 was bonded onto the surface, adjacent to the liquid crystal cell, of one substrate in the TN mode polarization-converting liquid crystal cell, while the laminate 18′ was bonded onto the surface, adjacent to the liquid crystal cell, of the other substrate. The laminate 18 was bonded into the arrangement shown in FIG. 3(c) to prepare a 3D display device 24.

### Example 25

Instead of the laminate 5′, a laminate 19 was prepared by subjecting a stack of two polymer films 4 to alkaline saponification, and then laminating the stack on one side of the polarizing film with a polyvinyl alcohol adhesive. An optically-anisotropic layer was formed as in Example 9 on the surface of the stack on which no polarizing film was laminated. A laminate 5 including no optically-anisotropic layer was bonded onto the surface, adjacent to the liquid crystal cell, of one substrate in the TN mode polarization-converting liquid crystal cell, while the laminate 19 was bonded onto the surface, adjacent to the liquid crystal cell, of the other substrate as in Example 9. The laminate 5 was bonded into the arrangement shown in FIG. 3(b) to prepare a 3D display device 25.

### Example 26

A laminate 5 including no optically-anisotropic layer was bonded onto one side of a polarizing film to prepare a laminate 20. The laminate 20 was bonded onto the surface, adjacent to the liquid crystal cell, of one substrate in the TN mode polarization-converting liquid crystal cell, while the laminate 5′ was bonded onto the surface, adjacent to the liquid crystal cell, of the other substrate as in Example 9. The laminate 20 was bonded into an O mode arrangement to prepare a 3D display device 26.

### Example 27

A 3D display device 27 was prepared as in Example 2, except that a PURE-ACE (from TEIJIN LIMITED) as a quarter-wave (λ/4) plate was laminated on the 3D display device 2 at the viewer side.

### Example 28

A 3D display device 28 was prepared as in Example 2, except that the TN mode polarization-converting liquid crystal cell which was used as a polarization-converting liquid crystal cell was replaced with a vertical alignment type (VA mode) liquid crystal cell assembled in a commercially available liquid crystal display (KDL-40J5000), off which the polarizing plate was peeled.

### Comparative Example 1

Laminates 21 and 21′ were prepared as in laminates 1 and 1′ in Example 1, except that the film 1 was replaced with the film 11. A 3D display device 29 was prepared using the resulting laminates 21 and 21′ as in Example 1, and the arrangement of the axis of each component during laminating processes was altered as shown in the table below.

### Comparative Example 2

A 3D display device 30 was prepared as in Comparative Example 1, except that the arrangement of the axis of each component during laminating processes was altered as shown in the table below.

### Comparative Example 3

A 3D display device 31 was prepared as in Comparative Example 1, except that the arrangement of the axis of each component during laminating processes was altered as shown in the table below.

### Comparative Example 4

A 3D display device 32 was prepared as in Comparative Example 1, except that the arrangement of the axis of each component during laminating processes was altered as shown in the table below.

### Comparative Example 5

Laminates 22 and 22′ were prepared as in laminates 1 and 1′ in Example 1, except that the film 1 was replaced with the film 12, and the arrangement of the axis of each component during laminating processes was altered as shown in the table below. A 3D display device 33 was prepared using the resulting laminates 22 and 22′ as in Example 1.

### Comparative Example 6

Laminates 23 and 23′ were prepared as in laminates 1 and 1′ in Example 1, except that the film 1 was replaced with the film 13. A 3D display device 34 was prepared using the resulting laminates 2 and 2′ as in Example 1.

### Comparative Example 7

Laminates 24 and 24′ were prepared as in laminates 1 and 1′ in Example 1, except that the film 1 was replaced with the film 14. A 3D display device 35 was prepared using the resulting laminates 24 and 24′ as in Example 1.

### Comparative Example 8

A 3D display device 36 was prepared as in Example 5, except that the arrangement of the axis of each component during laminating processes was altered as shown in the table below.

### Comparative Example 9

Laminates 25 and 25′ were prepared as in laminates 1 and 1′ in Example 1, except that the film 1 was replaced with the film 15. A 3D display device 37 was prepared using the resulting laminates 25 and 25′ as in Example 1.

### (Evaluation)

### (1) Crosstalk

Polarizing glasses were disposed at 45° in the azimuthal direction and at 60° in the polar direction seen from the front of the prepared 3D display device 1, with a line connecting right and left lenses of the glasses parallel to the ground. When a 3D content giving a white color for the right eye view and a black color for the left eye view was displayed on a 3D display device 1 in the dark, sensory evaluations were conducted only on the left eye of how black an image to be essentially black can be seen and the presence of an excess brightness phenomenon based on the following criteria. Likewise, 3D display devices 2 to 28 were also evaluated. Results are shown in the tables below. In these evaluations, circular polarizing glasses were used for a 3D display device 27 and linear polarizing glasses for 3D display devices other than the device 27.

### [Evaluation Criteria]

1. Completely black; no excess brightness was observed;
2. Substantially no excess brightness was observed;
3. Slightly excess brightness was observed;
4. Measurably excess brightness was observed;
5. Extremely excess brightness was observed.

### (2) White Color Shift

The polar angle from the front of a 3D display device 1 was set at 60° and the azimuth was rotated from 0 to 360°, the maximum value (Δu′v′) of chromaticity values at each angle (u′v′) was then measured with a luminance meter (BM-5A, from TOPCON). Likewise, 3D display devices 2 to 37 were also evaluated. Results are shown in the tables below.

### (3) Front Luminance

The luminance in the normal direction (front) to the display face was measured with a luminance meter (BM-5A, from TOPCON), and was evaluated on the basis of the front luminance in Example 1 of 100. Results are shown in the tables below.

TABLE 3

| | | Example 1 | Example 2 | Example 3 | Example 4 | Example 5 |
|---|---|---|---|---|---|---|
| Structure | | FIG. 2 | FIG. 2 | FIG. 2 | FIG. 2 | FIG. 2 |
| Liquid crystal cell | Mode | VA | VA | VA | VA | VA |
| for image display | | | | | | |
| First polarizing plate | Angle of the transmission axis | 90° | 90° | 90° | 90° | 90° |
| | seen from the front | | | | | |
| | Relationship between the front | Parallel | Parallel | Parallel | Parallel | Parallel |
| | side polarizing plate and | | | | | |
| | transmission axis | | | | | |
| Rear side retardation | Presence or absence of optically | Non-existence | Non-existence | Non-existence | Non-existence | Non-existence |
| plate | anisotropic layer | | | | | |
| | Re (nm) | 50 | 50 | 0 | 0 | 80 |
| | Rth (nm) | 120 | 120 | 150 | 150 | 140 |
| | Slow axis angle | Orthogonal(0°) | Orthogonal(0°) | Orthogonal(0°) | Orthogonal(0°) | Orthogonal(0°) |
| Polarization- | Δnd (nm) | 400 | 400 | 400 | 400 | 400 |
| converting liquid | Mode | TN | TN | TN | TN | TN |
| crystal cell | Disposition | E | O | E | O | O |
| | (E/OMode) | | | | | |
| Front side polarizing | Presence or absence of optically | Non-existence | Non-existence | Non-existence | Non-existence | Non-existence |
| plate | anisotropic layer | | | | | |
| | Re (nm) | 50 | 50 | 0 | 0 | 80 |
| | Rth (nm) | 120 | 120 | 150 | 150 | 140 |
| | Slow axis angle | Parallel(90°) | Parallel(90°) | Parallel(90°) | Parallel(90°) | Parallel(90°) |
| λ/4 plate | Existence or non-existence | Non-existence | Non-existence | Non-existence | Non-existence | Non-existence |
| Polarization state | | Linear | Linear | Linear | Linear | Linear |
| Evaluation | Crosstalk | 2 | 2 | 2 | 3 | 3 |
| | White color shift | 0.20 | 0.14 | 0.29 | 0.12 | 0.22 |
| | Front luminance | 100 | 100 | 100 | 100 | 100 |
| | | Example 6 | Example 7 | Example 8 | Example 9 | Example 10 |
| Structure | | FIG. 2 | FIG. 2 | FIG. 2 | FIG. 2 | FIG. 2 |
| Liquid crystal cell | Mode | VA | VA | VA | VA | VA |
| for image display | | | | | | |
| First polarizing plate | Angle of the transmission axis | 90° | 90° | 90° | 90° | 90° |
| | seen from the front | | | | | |
| | Relationship between the front | Parallel | Parallel | Parallel | Parallel | Parallel |
| | side polarizing plate and | | | | | |
| | transmission axis | | | | | |
| Rear side retardation | Presence or absence of optically | Non-existence | Non-existence | Non-existence | Existence | Existence |
| plate | anisotropic layer | | | | | |
| | Re (nm) | 80 | 0 | 0 | −10 | 20 |
| | Rth (nm) | 140 | 60 | 60 | 80 | 120 |
| | Slow axis angle | Orthogonal(0°) | Orthogonal(0°) | Orthogonal(0°) | Parallel(90°) | Orthogonal( 0°) |
| Polarization- | Δnd (nm) | 400 | 400 | 400 | 400 | 400 |
| converting liquid | Mode | TN | TN | TN | TN | TN |
| crystal cell | Disposition | E | E | O | O | O |
| | (E/OMode) | | | | | |
| Front side polarizing | Presence or absence of optically | Non-existence | Non-existence | Non-existence | Existence | Existence |
| plate | anisotropic layer | | | | | |
| | Re (nm) | 80 | 0 | 0 | −10 | 20 |
| | Rth (nm) | 140 | 60 | 60 | 80 | 120 |
| | Slow axis angle | Parallel(90°) | Parallel(90°) | Parallel(90°) | Orthogonal(0°) | Parallel(90°) |
| λ/4 plate | Existence or non-existence | Non-existence | Non-existence | Non-existence | Non-existence | Non-existence |
| Polarization state | | Linear | Linear | Linear | Linear | Linear |
| Evaluation | Crosstalk | 3 | 3 | 3 | 1 | 1 |
| | White color shift | 0.14 | 0.30 | 0.11 | 0.25 | 0.26 |
| | Front luminance | 100 | 100 | 100 | 100 | 100 |

* An angle of the transmission axis seen from the front is 90° indicates that the transmission axis is along the horizontal direction on the screen.
* The slow axis angle indicates a relationship with the transmission axis of the front polarizing plate. Numerals shown in parentheses are described with a horizontal direction defined as 0° and a vertical direction defined as 90°, and the counterclockwise direction defined as positive on the screen.

TABLE 4

| | | Example 11 | Example 12 | Example 13 | Example 14 |
|---|---|---|---|---|---|
| Structure | | FIG. 2 | FIG. 2 | FIG. 2 | FIG. 2 |
| Liquid crystal cell | Mode | VA | VA | VA | VA |
| for image display | | | | | |
| First polarizing | Angle of the transmission | 90° | 90° | 90° | 90° |
| plate | axis seen from the front | | | | |
| | Relationship between the | Parallel | Parallel | Parallel | Parallel |
| | front side polarizing plate | | | | |
| | and transmission axis | | | | |
| Rear side | Presence or absence of | Non-existence | Non-existence | Existence | Existence |
| retardation | optically anisotropic layer | | | | |
| plate | Re (nm) | 50 | 50 | 10 | 10 |
| | Rth (nm) | 120 | 120 | 100 | 135 |
| | Slow axis angle | Orthogonal(0°) | Orthogonal(0°) | Orthogonal(0°) | Orthogonal(0°) |
| Polarization- | Δnd (nm) | 460 | 460 | 460 | 460 |
| converting | Mode | TN | TN | TN | TN |
| liquid crystal | Disposition | E | O | O | O |
| cell | (E/O mode) | | | | |
| Front side | Presence or absence of | Non-existence | Non-existence | Existence | Existence |
| polarizing | optically anisotropic layer | | | | |
| plate | Re (nm) | 50 | 50 | 10 | 10 |
| | Rth (nm) | 120 | 120 | 100 | 135 |
| | Slow axis angle | Parallel(90°) | Parallel(90°) | Parallel(90°) | Parallel(90°) |
| λ/4 plate | Existence or non-existence | Non-existence | Non-existence | Non-existence | Non-existence |
| Polarization state | | Linear | Linear | Linear | Linear |
| Evaluation | Crosstalk | 2 | 2 | 1 | 1 |
| | White color shift | 0.22 | 0.18 | 0.26 | 0.27 |
| | Front luminance | 105 | 105 | 105 | 105 |

*: An angle of the transmission axis seen from the front is 90° indicates that the transmission axis is along the horizontal direction on the screen.
*: The slow axis angle indicates a relationship with the transmission axis of the front polarizing plate. Numerals shown in parentheses are described with a horizontal direction defined as 0° and a vertical direction defined as 90° counterclockwise direction defined as positive on the screen.

TABLE 5

| | | Example 15 | Example 16 | Example 17 | Example 18 | Example 19 | Example 20 | Example 21 |
|---|---|---|---|---|---|---|---|---|
| Structure | | FIG. 1 | FIG. 1 | FIG. 1 | FIG. 1 | FIG. 1 | FIG. 1 | FIG. 1 |
| Liquid crystal | Mode | VA | VA | VA | VA | VA | VA | VA |
| cell for | | | | | | | | |
| image display | | | | | | | | |
| First polarizing | Angle of the | 90° | 90° | 90° | 90° | 90° | 90° | 90° |
| plate | transmission axis | | | | | | | |
| | seen from the front | | | | | | | |
| | Relationship | — | — | — | — | — | — | — |
| | between the front | | | | | | | |
| | side polarizing | | | | | | | |
| | plate and | | | | | | | |
| | transmission axis | | | | | | | |
| Rear side | Presence or absence of optically | Non- | Existence | Existence | Non- | Existence | Existence | Non- |
| retardation | anisotropic layer | existence | | | existence | | | existence |
| plate | Re (nm) | 50 | 10 | 20 | 50 | 10 | 10 | 50 |
| | Rth (nm) | 120 | 80 | 120 | 120 | 100 | 135 | 120 |
| | Slow axis angle | Orthogonal | Orthogonal | Orthogonal | Orthogonal | Orthogonal | Orthogonal | Orthogonal |
| | | (0°) | (0°) | (0°) | (0°) | (0°) | (0°) | (0°) |
| Polarization- | Δnd (nm) | 400 | 400 | 400 | 460 | 460 | 400 | 400 |
| converting | Mode | TN | TN | TN | TN | TN | TN | TN |
| liquid | Disposition | E | O | O | E | O | O | O |
| crystal cell | (E/O mode) | | | | | | | |
| Front side | Presence or absence of optically | Non- | Existence | Existence | Non- | Existence | Existence | Non- |
| polarizing | anisotropic layer | existence | | | existence | | | existence |
| plate | Re (nm) | 50 | 10 | 20 | 50 | 10 | 10 | — |
| | Rth (nm) | 120 | 80 | 120 | 120 | 100 | 135 | — |
| | Slow axis angle | Parallel | Parallel | Parallel | Parallel | Parallel | Parallel | — |
| | | (90°) | (90°) | (90°) | (90°) | (90°) | (90°) | |
| λ/4 plate | Existence or | Non- | Non- | Non- | Non- | Non- | Non- | Non- |
| | non-existence | existence | existence | existence | existence | existence | existence | existence |
| Polarization state | | Linear | Linear | Linear | Linear | Linear | Linear | Linear |
| Evaluation | Crosstalk | 2 | 1 | 1 | 2 | 1 | 1 | 3 |
| | White color shift | 0.20 | 0.24 | 0.25 | 0.22 | 0.25 | 0.26 | 0.26 |
| | Front luminance | 103 | 103 | 103 | 108 | 108 | 108 | 100 |

* An angle of the transmission axis seen from the front is 90° indicates that the transmission axis is along the horizontal direction on the screen.
* The slow axis angle indicates a relationship with the transmission axis of the front polarizing plate. Numerals shown in parentheses are described with a horizontal direction defined as 0° and a vertical direction defined as 90°, and the counterclockwise direction defined as positive on the screen.

TABLE 6

| | | Example | Example | Example | Example | Example | Example | Example |
|---|---|---|---|---|---|---|---|---|
| | | 22 | 23 | 24 | 25 | 26 | 27 | 28 |
| Structure | | FIG. 2 | FIG. 2 | FIG. 2 | FIG. 2 | FIG. 2 | FIG. 2 | FIG. 2 |
| Liquid crystal | Mode | VA | VA | VA | VA | VA | VA | VA |
| cell for | | | | | | | | |
| image display | | | | | | | | |
| First polarizing | Angle of the | 90° | 90° | 90° | 90° | 90° | 90° | 90° |
| plate | transmission axis | | | | | | | |
| | seen from the front | | | | | | | |
| | Relationship | Parallel | Parallel | Parallel | Parallel | Parallel | Parallel | Parallel |
| | between the front | | | | | | | |
| | side polarizing | | | | | | | |
| | plate and | | | | | | | |
| | transmission axis | | | | | | | |
| Rear side | Presence or absence | Existence | Existence | Existence | Non- | Non- | Non- | Non- |
| retardation | of optically | | | | existence | existence | existence | existence |
| plate | anisotropic layer | | | | | | | |
| | Re (nm) | 80 | −10 | 80 | −10 | −10 | 50 | 50 |
| | Rth (nm) | 60 | 80 | 60 | 80 | 80 | 120 | 120 |
| | Slow axis angle | Orthogonal | Parallel | Orthogonal | Parallel | Parallel | Orthogonal | Orthogonal |
| | | (0°) | (90°) | (0°) | (90°) | (90°) | (0°) | (0°) |
| Polarization- | Δnd (nm) | 400 | 400 | 400 | 400 | 400 | 400 | 350 |
| converting | Mode | TN | TN | TN | TN | TN | TN | VA |
| liquid | Disposition | O | — | — | E | O | O | — |
| crystal cell | (E/O mode) | | | | | | | |
| Front side | Presence or absence | Existence | Existence | Existence | Existence | Existence | Non- | Non- |
| polarizing | of optically | | | | | | existence | existence |
| plate | anisotropic layer | | | | | | | |
| | Re (nm) | 80 | −10 | 80 | 0 | −10 | 50 | 50 |
| | Rth (nm) | 60 | 80 | 60 | 120 | 80 | 120 | 120 |
| | Slow axis angle | Parallel | Parallel | Parallel | Orthogonal | Orthogonal | Parallel | Parallel |
| | | (90°) | (90°) | (90°) | (0°) | (0°) | (90°) | (90°) |
| λ/4 plate | Existence or | Non- | Non- | Non- | Non- | Non- | Existence | Non- |
| | non-existence | existence | existence | existence | existence | existence | | existence |
| Polarization state | | Linear | Linear | Linear | Linear | Linear | Circular | Linear |
| Evaluation | Crosstalk | 1 | 2 | 1 | 3 | 2 | 2 | 1 |
| | White color shift | 0.30 | 0.44 | 0.28 | 0.31 | 0.15 | 0.14 | 0.18 |
| | Front luminance | 100 | 90 | 90 | 100 | 100 | 100 | 90 |

* An angle of the transmission axis seen from the front is 90° indicates that the transmission axis is along the horizontal direction on the screen.
* The slow axis angle indicates a relationship with the transmission axis of the front polarizing plate. Numerals shown in parentheses are described with a horizontal direction defined as 0° and a vertical direction defined as 90°, and the counterclockwise direction defined as positive on the screen.

TABLE 7

| | | Comparative | Comparative | Conparative | Comparative | Comparative |
|---|---|---|---|---|---|---|
| | | example 1 | example 2 | example 3 | example 4 | example 5 |
| Structure | | FIG. 2 | FIG. 2 | FIG. 2 | FIG. 2 | FIG. 2 |
| Liquid crystal cell for | Mode | VA | VA | VA | VA | VA |
| image display | | | | | | |
| First polarizing plate | Angle of the transmission axis | 90° | 90° | 90° | 90° | 90° |
| | seen from the front | | | | | |
| | Relationship between the front | Parallel | Parallel | Parallel | Parallel | Parallel |
| | side polarizing plate and | | | | | |
| | transmission axis | | | | | |
| Rear side retardation | Presence or absence of optically | Non-existence | Non-existence | Non-existence | Non-existence | Non-existence |
| plate | anisotropic layer | | | | | |
| | Re (nm) | −10 | −10 | −10 | −10 | −40 |
| | Rth (nm) | 40 | 40 | 40 | 40 | 50 |
| | Slow axis angle | Parallel(90°) | 100° | 80° | 45° | Parallel(90°) |
| Polarization- | Δnd (nm) | 400 | 400 | 400 | 400 | 400 |
| converting liquid | Mode | TN | TN | TN | TN | TN |
| crystal cell | Disposition | E | E | E | E | E |
| | (E/O mode) | | | | | |
| Front side polarizing | Presence or absence of optically | Non-existence | Non-existence | Non-existence | Non-existence | Non-existence |
| plate | anisotropic layer | | | | | |
| | Re (nm) | −10 | −10 | −10 | −10 | −40 |
| | Rth (nm) | 40 | 40 | 40 | 40 | 50 |
| | Slow axis angle | Orthogonal(0°) | 10° | −10° | 135° | Orthogonal(0°) |
| λ/4 plate | Existence or non-existence | Non-existence | Non-existence | Non-existence | Non-existence | Non-existence |
| Polarization state | | Linear | Linear | Linear | Linear | Linear |
| Evaluation | Crosstalk | 4 | 5 | 5 | 5 | 5 |
| | White color shift | 0.30 | 0.40 | 0.40 | 0.50 | 0.35 |
| | Front luminance | 100 | 95 | 95 | 90 | 100 |

| | | Comparative | Comparative | Comparative | Comparative |
|---|---|---|---|---|---|
| | | example 6 | example 7 | example 8 | example 9 |
| Structure | | FIG. 2 | FIG. 2 | FIG. 2 | FIG. 2 |
| Liquid crystal cell for | Mode | VA | VA | VA | VA |
| image display | | | | | |
| First polarizing plate | Angle of the transmission axis | 90° | 90° | 90° | 90° |
| | seen from the front | | | | |
| | Relationship between the front | Parallel | Parallel | Parallel | Parallel |
| | side polarizing plate and | | | | |
| | transmission axis | | | | |
| Rear side retardation | Presence or absence of optically | Non-existence | Non-existence | Non-existence | Non-existence |
| plate | anisotropic layer | | | | |
| | Re (nm) | 120 | 50 | −80 | 30 |
| | Rth (nm) | 150 | 230 | 140 | 40 |
| | Slow axis angle | Orthogonal(0°) | Orthogonal(0°) | Parallel(90°) | Orthogonal(0°) |
| Polarization- | Δnd (nm) | 400 | 400 | 400 | 400 |
| converting liquid | Mode | TN | TN | TN | TN |
| crystal cell | Disposition | E | E | E | E |
| | (E/O mode) | | | | |
| Front side polarizing | Presence or absence of optically | Non-existence | Non-existence | Non-existence | Non-existence |
| plate | anisotropic layer | | | | |
| | Re (nm) | 120 | 50 | −80 | 30 |
| | Rth (nm) | 150 | 230 | 140 | 40 |
| | Slow axis angle | Parallel(90°) | Parallel(90°) | Orthogonal(0°) | Parallel(90°) |
| λ/4 plate | Existence or non-existence | Non-existence | Non-existence | Non-existence | Non-existence |
| Polarization state | | Linear | Linear | Linear | Linear |
| Evaluation | Crosstalk | 4 | 4 | 4 | 4 |
| | White color shift | 0.13 | 0.18 | 0.54 | 0.28 |
| | Front luminance | 100 | 100 | 100 | 100 |

* An angle of the transmission axis seen from the front is 90° indicates that the transmission axis is along the horizontal direction on the screen.
* The slow axis angle indicates a relationship with the transmission axis of the front polarizing plate. Numerals shown in parentheses are described with a horizontal direction defined as 0° and a vertical direction defined as 90°, and the counterclockwise direction defined as positive on the screen.

The results in the tables described above show that at least one retardation layer between the polarization-converting liquid crystal cell and the first polarizing film and/or in front of the polarization-converting liquid crystal cell wherein polymer films in the retardation layer have a retardation Re (550) in plane of −30 to 100 nm and a retardation Rth (550) in the thickness direction of 50 to 180 nm reduces the crosstalk and white color shift, and improves the front luminance.
1 3D display device
2 Polarizing glasses
10 Liquid crystal cell for image display
12 Polarization-converting liquid crystal cell
12a
12a′
14 First polarizing film
14a Transmission axis of the first polarizing film
15 Polarizing film
15a Transmission axis of the polarizing film 15
16 Retardation layer (Polymer film)
16a Slow axis of the retardation layer (Polymer film)
18 Retardation layer (Polymer film)
18a Slow axis of the retardation layer (Polymer film)
20 Second polarizing film
20a Transmission axis of the second polarizing film

1. A 3D display device comprising:
a liquid crystal cell for image display;
a first polarizing film and a polarization-converting liquid crystal cell in this order in front of the liquid crystal cell for image display;
at least one retardation layer between the polarization-converting liquid crystal cell and the first polarizing film and/or in front of the polarization-converting liquid crystal cell, the at least one retardation layer comprising a polymer film or consisting of a polymer film,
wherein the polymer films have a retardation Re (550) in plane at a wavelength of 550 nm of −30 to 100 nm and a retardation Rth (550) in the thickness direction at a wavelength of 550 nm of 50 to 180 nm.

2. The 3D display device in accordance with claim 1, wherein the slow axis of the polymer film is orthogonal to, is parallel to, or intersects, at 45°, the transmission axis of the first polarizing film.

3. The 3D display device in accordance with claim 1, which comprises at least two retardation layers, one of the retardation layers being disposed between the polarization-converting liquid crystal cell and the first polarizing film, and other one of the retardation layers being disposed in front of the polarization-converting liquid crystal cell.

4. The 3D display device in accordance with claim 3, wherein the polymer films are disposed such that slow axes thereof are orthogonal to each other.

5. The 3D display device in accordance with claim 1, further comprising an additional polarizing film between the liquid crystal cell for image display and the first polarizing film, the additional polarizing film having a transmission axis parallel to the transmission axis of the first polarizing film.

6. The 3D display device in accordance with claim 1, further comprising a second polarizing film behind the liquid crystal cell for image display, the second polarizing film having a transmission axis orthogonal to the transmission axis of the first polarizing film.

7. The 3D display device in accordance with claim 1, wherein the retardation layer comprises a polymer film and an optically anisotropic layer on the polymer film, the optically anisotropic layer comprising a composition containing a liquid crystal compound.

8. The 3D display device in accordance with claim 1, wherein the polymer film is a cellulose acylate film.

9. The 3D display device in accordance with claim 1, wherein the polymer film is an optically biaxial polymer film.

10. The 3D display device in accordance with claim 1, wherein the first polarizing film and the polarization-conversion liquid crystal cell are in an E mode or an O mode.

11. The 3D display device in accordance with claim 1, wherein the liquid crystal cell for image display is a VA mode, the transmission axis of the first polarizing film is parallel to the horizontal or vertical direction of a display face.

12. The 3D display device in accordance with claim 1, wherein the polarization-conversion liquid crystal cell is a TN mode.

13. The 3D display device in accordance with claim 1, wherein the polarization-conversion liquid crystal cell is a VA mode.

14. The 3D display device in accordance with claim 1, wherein the slow axis of the polymer film is orthogonal to, is parallel to, or intersects, at 45°, the transmission axis of the first polarizing film; and
which comprises at least two retardation layers, one of the retardation layers being disposed between the polarization-converting liquid crystal cell and the first polarizing film, and other one of the retardation layers being disposed in front of the polarization-converting liquid crystal cell.

15. The 3D display device in accordance with claim 1, which comprises at least two retardation layers, one of the retardation layers being disposed between the polarization-converting liquid crystal cell and the first polarizing film, and other one of the retardation layers being disposed in front of the polarization-converting liquid crystal cell; and
wherein the slow axis of the polymer film is orthogonal to, is parallel to, or intersects, at 45°, the transmission axis of the first polarizing film; and the polymer films are disposed such that slow axes thereof are orthogonal to each other.

16. The 3D display device in accordance with claim 1, wherein the slow axis of the polymer film is orthogonal to, is parallel to, or intersects, at 45°, the transmission axis of the first polarizing film; and
which comprises at least two retardation layers, one of the retardation layers being disposed between the polarization-converting liquid crystal cell and the first polarizing film, and other one of the retardation layers being disposed in front of the polarization-converting liquid crystal cell; and
further comprises an additional polarizing film between the liquid crystal cell for image display and the first polarizing film, the additional polarizing film having a transmission axis parallel to the transmission axis of the first polarizing film.

17. The 3D display device in accordance with claim 1, wherein the slow axis of the polymer film is orthogonal to, is parallel to, or intersects, at 45°, the transmission axis of the first polarizing film; and
which comprises at least two retardation layers, one of the retardation layers being disposed between the polarization-converting liquid crystal cell and the first polarizing film, and other one of the retardation layers being disposed in front of the polarization-converting liquid crystal cell; and
further comprises a second polarizing film behind the liquid crystal cell for image display, the second polarizing film having a transmission axis orthogonal to the transmission axis of the first polarizing film.

18. The 3D display device in accordance with claim 1, wherein the slow axis of the polymer film is orthogonal to, is parallel to, or intersects, at 45°, the transmission axis of the first polarizing film; and
the retardation layer comprises a polymer film and an optically anisotropic layer on the polymer film, the optically anisotropic layer comprising a composition containing a liquid crystal compound; and
which comprises at least two retardation layers, one of the retardation layers being disposed between the polarization-converting liquid crystal cell and the first polarizing film, and other one of the retardation layers being disposed in front of the polarization-converting liquid crystal cell.

19. The 3D display device in accordance with claim 1, wherein the slow axis of the polymer film is orthogonal to, is parallel to, or intersects, at 45°, the transmission axis of the first polarizing film; and
the first polarizing film and the polarization-conversion liquid crystal cell are in an E mode or an O mode; and
which comprises at least two retardation layers, one of the retardation layers being disposed between the polarization-converting liquid crystal cell and the first polarizing film, and other one of the retardation layers being disposed in front of the polarization-converting liquid crystal cell.

20. A 3D display system comprising:
a 3D display device in accordance with claim 1; and
a third polarizing film that transmits images displayed on the 3D display system to be visualized as 3D images.
